(19) United States
(12) Patent Application Publication
(10) Pub. No.: US 2018/0282190 A1
(43) Pub. Date: Oct. 4, 2018

(54) A CLOGGING RESISTANT BIOFILM-BASED WATER TREATMENT SYSTEM

(71) Applicant: EMEFCY LTD., Caesarea (IL)

(72) Inventors: Ronen Itzhak SHECHTER, Kiryat Tivon (IL); Eytan Baruch LEVY, Rosh Ha-ain (IL); Lior ESHED, Haifa (IL); Yaron BAR-TAL, Ganey Tikvah (IL); Tomer SPECTOR, Petach Tikva (IL); Noam Mordechai SIEGEL, Tel-Aviv (IL)

(73) Assignee: EMEFCY LTD., Caesarea (IL)

(21) Appl. No.: 15/755,223

(22) PCT Filed: Aug. 25, 2016
(86) PCT No.: PCT/IL2016/050932

§ 371 Date: Feb. 26, 2018

Related U.S. Application Data
(60) Provisional application No. 62/209,891, filed on Aug. 26, 2015.

(51) Int. Cl. C02F 3/30; C02F 3/10; B01D 65/08; C02F 1/52; C02F 3/20

(52) U.S. Cl. CPC C02F 3/305; C02F 3/102; C02F 2101/30; C02F 1/5245; C02F 3/208; B01D 65/08

(57) ABSTRACT

Provided is a clogging resistant biofilm-based water treatment system. The system includes a membrane-enclosed water flow pathway including at least one water-impermeable, oxygen-permeable membrane wall portion extending along the pathway and at least another wall portion extending along at least part of the pathway. According to the subject matter provided, biofilm growth and consequent clogging generally takes place along the water-impermeable, oxygen-permeable membrane wall portion and biofilm growth and clogging does not take place along the another wall portion.

### SUMMARY OF THE INVENTION

The present invention seeks to provide improved methodologies and systems for water treatment.

There is thus provided in accordance with a preferred embodiment of the present invention a clogging resistant biofilm-based water treatment system, including a membrane-enclosed water flow pathway including at least one water-impermeable, oxygen-permeable membrane wall portion extending along the pathway and at least another wall portion extending along at least part of the pathway, wherein biofilm growth and consequent clogging generally takes place along the water-impermeable, oxygen-permeable membrane wall portion and biofilm growth and clogging does not take place along the another wall portion.

In accordance with a preferred embodiment of the present invention the at least another wall portion includes at least one water-impermeable, oxygen-impermeable wall portion extending along at least part of the pathway, wherein biofilm growth and consequent clogging generally takes place along the water-impermeable, oxygen-permeable membrane wall portion and clogging does not take place along the water-impermeable, oxygen-impermeable wall portion.

Preferably, the at least another wall portion includes a plurality of water-impermeable, oxygen-impermeable wall portions interspersed with water-impermeable, oxygen-permeable wall portions and extending along at least part of the pathway, and biofilm growth and consequent clogging which prevents water flow but not oxygen permeation generally takes place along the water-impermeable, oxygen-permeable membrane wall portion and clogging which prevents water flow generally does not take place along the water-impermeable, oxygen-impermeable wall portions, such that water to be treated can flow along generally the entire length of the pathway notwithstanding biofilm clogging of the plurality of water-impermeable, oxygen-permeable membrane wall portions into engagement with the biofilm on the water-impermeable, oxygen-permeable wall portions and oxygen diffuses into the biofilm.

Preferably, a surface area of the water-impermeable, oxygen-permeable membrane wall portion is at least 80% of the surface area of the at least part of the pathway.

In accordance with a preferred embodiment of the present invention the at least one water-impermeable, oxygen-impermeable wall portion extends continuously along at least part of the pathway. Additionally or alternatively, the at least one water-impermeable, oxygen-impermeable wall portion includes plural water-impermeable, oxygen-impermeable wall portions. Additionally or alternatively, the at least one water-impermeable, oxygen-impermeable membrane wall portion is formed of the at least one water-impermeable, oxygen-permeable membrane overlaid with an oxygen-impermeable layer. Preferably, the oxygen-impermeable layer is formed from at least one of an adhesive, a heat laminatable surface; and a thermoplastic polymer.

In accordance with a preferred embodiment of the present invention the plurality of water-impermeable, oxygen-impermeable wall portions and the plurality of water-impermeable, oxygen-permeable wall portions extends continuously along at least part of the pathway. Additionally or alternatively, a cumulative width of the oxygen-permeable membrane wall portions is greater than the cumulative width of the plurality of water-impermeable, oxygen-impermeable wall portions.

Preferably, the wall portion surface area of the plurality of water-impermeable, oxygen-impermeable wall portions is between 20% and 50% of the wall portion surface area of the plurality of water-impermeable, oxygen-permeable wall portions. Additionally or alternatively, the width of each of the plurality of water-impermeable, oxygen-impermeable wall portions is between 10-50 mm. Additionally or alternatively, the plurality of water-impermeable, oxygen-impermeable membrane wall portions are formed of the at least one water-impermeable, oxygen-permeable membrane overlaid with an oxygen-impermeable layer.

In accordance with a preferred embodiment of the present invention the membrane-enclosed water flow pathway includes an upstream region, including a plurality of water-impermeable, oxygen-permeable membrane wall portions extending along the pathway interspersed with a plurality of water-impermeable, oxygen-impermeable wall portions extending along at least part of the pathway, wherein biofilm growth and consequent clogging which prevents water flow but not oxygen permeation generally takes place along the water-impermeable, oxygen-permeable membrane wall portion and clogging which prevents water flow does not take place along the water-impermeable, oxygen-impermeable wall portions, such that water to be treated can flow along generally the entire length of the pathway notwithstanding biofilm clogging of the plurality of water-impermeable, oxygen-permeable membrane wall portions into engagement with the biofilm on the water-impermeable, oxygen-permeable wall portions and oxygen diffuses into the biofilm, and a downstream region including a water-impermeable, oxygen-permeable membrane wall portion.

In accordance with a preferred embodiment of the present invention the membrane-enclosed water flow pathway has a cross-sectional configuration defining a pair of generally parallel mutually spaced sides, separated by at least a minimum transverse separation and the plurality of water-impermeable, oxygen-impermeable wall portions each having a width which is at least twice as large as the minimum transverse separation.

There is also provided in accordance with another preferred embodiment of the present invention a clogging resistant biofilm-based water treatment method including causing water to be treated to flow along a membrane-enclosed water flow pathway including at least one water-impermeable, oxygen-permeable membrane wall portion extending along the pathway and at least another wall portion extending along at least part of the pathway, wherein biofilm growth and consequent clogging generally takes place along the water-impermeable, oxygen-permeable membrane wall portion and biofim growth and clogging does not take place along the another wall portion.

There is further provided in accordance with yet another preferred embodiment of the present invention a clogging resistant biofilm-based water treatment method including causing water to be treated to flow along a membrane-enclosed water flow pathway including at least one water-impermeable, oxygen-permeable membrane wall portion extending along the pathway and at least one water-impermeable, oxygen-impermeable wall portion extending along at least part of the pathway, wherein biofilm growth and consequent clogging generally takes place along the water-impermeable, oxygen-permeable membrane wall portion and clogging does not take place along the water-impermeable, oxygen-impermeable wall portion.

Preferably, the causing water to be treated to flow includes causing water containing organic material and ammonium compounds to flow along the pathway.

In accordance with a preferred embodiment of the present invention at an initial process phase most of the organic material is oxygenated in a first region of the pathway, at a second process phase, biofilm growth clogs at least most of the at least one water-impermeable, oxygen-permeable membrane wall portion in the first region of the pathway, such that the water to be treated, containing organic material, travels through the first region to a second region of the pathway, at a third process phase, clogging of at least most of the at least one water-impermeable, oxygen-permeable membrane wall portion in the first region of the pathway, generally blocks oxygen supply to the biofilm along the at least one water-impermeable, oxygen-permeable membrane wall portion in the first region of the pathway, causing at least partial disintegration of the biofilm along the at least one water-impermeable, oxygen-permeable membrane wall portion in the first region of the pathway and resulting at least partial unclogging thereof and at a fourth process phase, biofilm growth clogs at least most of the at least one water-impermeable, oxygen-permeable membrane wall portion in the second region of the pathway, such that the water to be treated, containing organic material, travels along the at least one water-impermeable, oxygen-impermeable membrane wall portion through the second region to a third region of the pathway.

Alternatively, at an initial process phase most of the organic material is oxygenated in a first region of the pathway, at a second process phase, biofilm growth clogs at least most of the at least one water-impermeable, oxygen-permeable membrane wall portion in the first region of the pathway but does not clog at least most of the at least one water-impermeable, oxygen-impermeable membrane wall portion in the first region of the pathway, such that the water to be treated, containing organic material, travels along the at least one water-impermeable, oxygen-impermeable membrane wall portion through the first region to a second region of the pathway, at a third process phase, clogging of at least most of the at least one water-impermeable, oxygen-permeable membrane wall portion in the first region of the pathway, generally blocks oxygen supply to the biofilm along the at least one water-impermeable, oxygen-permeable membrane wall portion in the first region of the pathway, causing at least partial disintegration of the biofilm along the at least one water-impermeable, oxygen-permeable membrane wall portion in the first region of the pathway and resulting at least partial unclogging thereof and at a fourth process phase, biofilm growth clogs at least most of the at least one water-impermeable, oxygen-permeable membrane wall portion in the second region of the pathway but does not clog at least most of the at least one water-impermeable, oxygen-impermeable membrane wall portion in the second region of the pathway, such that the water to be treated, containing organic material, travels along the at least one water-impermeable, oxygen-impermeable membrane wall portion through the second region to a third region of the pathway.

Additionally, at a fifth process phase clogging of at least most of the at least one water-impermeable, oxygen-permeable membrane wall portion in the second region of the pathway, generally blocks oxygen supply to the biofilm along the at least one water-impermeable, oxygen-permeable membrane wall portion in the second region of the pathway, causing at least partial disintegration of the biofilm along the at least one water-impermeable, oxygen-permeable membrane wall portion in the second region of the pathway and resulting at least partial unclogging thereof.

In accordance with a preferred embodiment of the present invention most of the ammonium compounds are oxygenated in regions of the pathway which are downstream of the first and second regions.

Preferably, the duration of the initial process phase is less than six months. Additionally or alternatively, duration of the second process phase is less than six months. Alternatively or additionally, the duration of the third process phase is less than six months.

In accordance with a preferred embodiment of the present invention the second and third process phases at least partially overlap in time. Additionally or alternatively, at least some of the initial, second, third and fourth process phases at least partially overlap in time.

There is yet further provided in accordance with still another preferred embodiment of the present invention a clogging resistant biofilm-based water treatment method including causing water to be treated to flow along a membrane-enclosed water flow pathway including a plurality of water-impermeable, oxygen-permeable membrane wall portions extending along the pathway interspersed with a plurality of water-impermeable, oxygen-impermeable wall portions extending along at least part of the pathway, wherein biofilm growth and consequent clogging which prevents water flow but not oxygen permeation generally takes place along the water-impermeable, oxygen-permeable membrane wall portion and clogging which prevents water flow does not take place along the water-impermeable, oxygen-impermeable wall portions, such that water to be treated can flow along generally the entire length of the pathway notwithstanding biofilm clogging of the plurality of water-impermeable, oxygen-permeable membrane wall portions into engagement with the biofilm on the water-impermeable, oxygen-permeable wall portions and oxygen diffuses into the biofilm.

Preferably, the causing water to be treated to flow includes causing water containing organic material and ammonium compounds to flow along the pathway.

In accordance with a preferred embodiment of the present invention a cumulative width of the oxygen-permeable membrane wall portions is greater than the cumulative width of the plurality of water-impermeable, oxygen-impermeable wall portions.

There is even further provided in accordance with another preferred embodiment of the present invention a water-impermeable, oxygen permeable membrane system including a water flow pathway including a first water-impermeable, oxygen-permeable membrane wall portion extending along at least part of the pathway and having an inside surface and an outside surface and a second water-impermeable wall portion extending along at least part of the pathway, the second wall portion being sealed to the inside surface of the first wall portion at along part of its periphery thereby to define at least part of the water flow pathway and being configured to define an air-flow pathway between the outside surface of the first wall portion and an adjacent surface of the second wall portion and to define a water-flow pathway between the inside surface of the first wall portion and an adjacent surface of the second wall portion.

Preferably, the second water impermeable wall portion includes an oxygen-permeable membrane.

In accordance with a preferred embodiment of the present invention the second water impermeable wall portion includes a wall portion having greater thickness and greater stiffness than the first water-impermeable, oxygen-permeable membrane wall portion.

Preferably, the first water-impermeable, oxygen permeable membrane wall portion and the second water-impermeable wall portion are wound together in a spiral-wound configuration. In accordance with a preferred embodiment of the present invention the first water-impermeable, oxygen permeable membrane wall portion and the second water-impermeable wall portion are stacked together.

In accordance with a preferred embodiment of the present invention the second water impermeable wall is oxygen-impermeable.

Preferably, the second wall portion includes at least one of plastic netting and dimpled sheet. Additionally, the second wall portion comprises at least one of a bi-planar and a tri-planar plastic netting. In accordance with a preferred embodiment of the present invention the second wall portion comprises a dimpled sheet including one sided or double sided dimples.

In accordance with a preferred embodiment of the present invention the air flow pathway has a transverse distance of between 4-10 mm between the outside surface of the first wall portion and the adjacent surface of the second wall portion. Additionally or alternatively, the water flow pathway has a transverse distance of 2-8 mm between the inside surface of the first wall portion and the adjacent surface of the second wall portion.

There is also provided in accordance with still another preferred embodiment of the present invention a water treatment system, including a membrane-enclosed water flow pathway receiving contaminant-containing water to be treated and at least one contaminant precipitating chemical, wherein at least one contaminant is precipitated along the water flow pathway and a back-flow cleaning subsystem operative to back-flush at least part of the membrane-enclosed water flow pathway, thereby removing therefrom the at least one precipitated contaminant.

Preferably, the contaminant-containing water contains phosphate, the contaminant precipitating chemical includes ferric cations and the precipitated contaminant includes ferric phosphate. In accordance with a preferred embodiment of the present invention the contaminant-containing water contains sulfide, the contaminant precipitating chemical includes at least one of ferric and aluminum cations and the precipitated contaminant includes at least one of ferric sulfide and aluminum sulfide. Preferably, the contaminant-containing water contains at least one heavy metal, the contaminant precipitating chemical includes a base and the precipitated contaminant includes metal hydroxides.

In accordance with a preferred embodiment of the present invention the membrane-enclosed water flow pathway forms part of an aerobic biological water treatment system. Additionally or alternatively, the back-flow cleaning subsystem includes an air scouring subsystem operative along at least part of the membrane-enclosed water flow pathway.

There is further provided in accordance with yet another preferred embodiment of the present invention a water treatment method including causing contaminant-containing water to be treated and at least one contaminant precipitating chemical to flow through a membrane-enclosed water flow pathway, wherein at least one contaminant is precipitated along the water flow pathway and back-flushing at least part of the membrane-enclosed water flow pathway, thereby removing therefrom the at least one precipitated contaminant.

Preferably, the contaminant-containing water contains phosphate, the contaminant precipitating chemical includes ferric cations and the precipitated contaminant includes ferric phosphate. In accordance with a preferred embodiment of the present invention the contaminant-containing water contains sulfide, the contaminant precipitating chemical includes at least one of ferric and aluminum cations and the precipitated contaminant includes at least one of ferric sulfide and aluminum sulfide. Preferably, the contaminant-containing water contains at least one heavy metal, the contaminant precipitating chemical includes a base and the precipitated contaminant includes metal hydroxides.

In accordance with a preferred embodiment of the present invention the membrane-enclosed water flow pathway forms part of an aerobic biological water treatment system. Additionally or alternatively, the back-flushing includes air scouring along at least part of the membrane-enclosed water flow pathway.

There is yet further provided in accordance with still another preferred embodiment of the present invention a clogging resistant biofilm-based water treatment method including causing water to be treated, containing both dissolved organic material and ammonium compounds, to be mixed with sludge, producing a first mixture containing suspended biomass and resulting in adsorption by the sludge of at least most of the dissolved organic material, following the adsorption, separating the sludge having adsorbed thereon the dissolved organic material, from liquid, which contains the ammonium compounds, causing the liquid to be treated to flow along an oxygen-permeable membrane-enclosed, water impermeable water flow pathway, thereby biologically nitrifying the ammonium compounds in the liquid, following the nitrifying, mixing the liquid containing nitrified ammonium compounds with the sludge having adsorbed thereon the dissolved organic material to create a second mixture, thereby producing denitrification of the nitrified ammonium compounds and oxidation of the organic material which had been adsorbed onto the sludge and following the denitrification, separating the sludge from water, wherein the water has substantially decreased amounts of dissolved organic material and ammonium compounds as compared with the water to be treated.

Preferably, the first mixture has suspended biomass at a concentration of at least 1000 mg/liter. Additionally or alternatively, the method also includes utilizing the sludge separated from the water following the denitrification to be mixed with the water to be treated, which contains both dissolved organic material and ammonium compounds.

In accordance with a preferred embodiment of the present invention the oxygen-permeable membrane-enclosed, water impermeable water flow pathway includes an elongated membrane enclosed generally horizontal flow path for water including an inlet for water to be treated at a first end of the horizontal flow path, an outlet for treated water on a second end of the horizontal flow path and an oxygen permeable membrane, defining a tubular water pathway having an inside surface exposed to water and an outside surface exposed to ambient air, the oxygen permeable membrane supporting a biofilm on the inside surface, the oxygen permeable membrane being arranged to define at least one generally vertical airflow passageway communicating with the outside surface. Additionally, the horizontal flow path is spirally wound and the at least one generally vertical airflow passageway has a generally spiral cross section. Additionally or alternatively, the generally horizontal flow path and the at least one generally vertical airflow passageway are enclosed within a generally vertical cylindrical enclosure. In accordance with a preferred embodiment of the present invention the generally horizontal flow path has a tapered top surface region.

In accordance with a preferred embodiment of the present invention mutually adjacent inside surfaces of the tubular water pathway are separated by at least one interior spacer. Additionally or alternatively, mutually adjacent outside surfaces of the tubular water pathway are separated by at least one exterior spacer.

In accordance with a preferred embodiment of the present invention mutually adjacent outside surfaces of the tubular water pathway are separated by a transverse distance of 4-20 mm. Additionally or alternatively, the spacer includes at least one of: drainage netting, reinforcement mesh, a screen and a three-dimensional plastic mesh grid.

There is also provided in accordance with another preferred embodiment of the present invention a clogging resistant biofilm-based water treatment method including causing water to be treated to flow initially along a first upstream membrane-enclosed water flow pathway portion including at least one upstream water-impermeable, oxygen-permeable membrane wall portion extending along the first upstream membrane-enclosed water flow pathway and thence along a downstream membrane-enclosed water flow pathway portion including at least one downstream water-impermeable, oxygen-permeable membrane wall portion extending along the downstream membrane-enclosed water flow pathway, upon clogging of the first upstream membrane-enclosed water flow pathway portion, causing water to be treated to flow along at least one second upstream membrane-enclosed water flow pathway portion including at least one upstream water-impermeable, oxygen-permeable membrane wall portion extending along the first upstream membrane-enclosed water flow pathway and thence along the downstream upstream membrane-enclosed water flow pathway portion including at least one downstream water-impermeable, oxygen-permeable membrane wall portion extending along the downstream membrane-enclosed water flow pathway, upon subsequent unclogging of the first upstream membrane-enclosed water flow pathway portion, causing water to be treated to flow initially along a first upstream membrane-enclosed water flow pathway portion including at least one upstream water-impermeable, oxygen-permeable membrane wall portion extending along the first upstream membrane-enclosed water flow pathway and thence along a downstream upstream membrane-enclosed water flow pathway portion including at least one downstream water-impermeable, oxygen-permeable membrane wall portion extending along the downstream membrane-enclosed water flow pathway.

Preferably, the method also includes at least partially unclogging the first upstream membrane-enclosed water flow pathway portion. Additionally, the at least partially unclogging the first upstream membrane-enclosed water flow pathway portion includes at least one of terminating flow of water to be treated through the first upstream membrane-enclosed water flow pathway portion for a sufficient duration to provide acceptable partial unclogging by aerobic endogenous decay, causing gas bubbles to scour the first upstream membrane-enclosed water flow pathway portion and circulating fluid through the first upstream membrane-enclosed water flow pathway portion, thereby creating shear forces which dislodge biofilm from the first upstream membrane-enclosed water flow pathway portion.

In accordance with a preferred embodiment of the present invention the water treatment method also includes discharging treated water directly from the membrane-enclosed water flow pathway without filtering.

In accordance with a preferred embodiment of the present invention the water treatment method also includes discharging treated water directly from the membrane-enclosed water flow pathway, the treated water having a suspended solids concentration of less than 50 mg/liter. Preferably, the water treatment method also includes discharging treated water directly from the membrane-enclosed water flow pathway, the treated water having a suspended solids concentration of less than 35 mg/liter.

There is still further provided in accordance with even a further preferred embodiment of the present invention a water treatment system including at least one settling pond receiving water to be treated, at least one oxidation pond receiving water from the at least one setting pond and a membrane-enclosed water flow pathway receiving water from the at least one oxidation pond and discharging water back to at least one of the at least one settling pond and the at least one oxidation pond and including at least one water-impermeable, oxygen-permeable membrane wall portion extending along the pathway, wherein clogging normally does not take place along the water-impermeable, oxygen-permeable membrane wall portion.

Preferably, the membrane-enclosed water flow pathway also includes at least one other wall portion, wherein biofilm growth and consequent clogging does not take place along the at least one other wall portion. Additionally or alternatively, the at least one other wall portion includes at least one water-impermeable, oxygen-impermeable wall portion extending along at least part of the pathway, wherein biofilm growth and consequent clogging generally takes place along the water-impermeable, oxygen-permeable membrane wall portion and clogging does not take place along the water-impermeable, oxygen-impermeable wall portion.

In accordance with a preferred embodiment of the present invention the water treatment system also includes at least one settling pond receiving water to be treated and at least one oxidation pond receiving water from the at least one setting pond, the membrane-enclosed water flow pathway receiving water from the at least one oxidation pond and discharging water back to at least one of the at least one settling pond and the at least one oxidation pond.

### BRIEF DESCRIPTION OF THE DRAWINGS

The present invention will be understood and appreciated more fully from the following detailed description, taken in conjunction with the drawings in which:

FIGS. 1A and 1B are each a simplified illustration of a different example of a clogging resistant biofilm-based water treatment system, constructed and operative in accordance with a preferred embodiment of the present invention;

FIGS. 2A and 2B are simplified pictorial illustrations of water and air flows in the embodiments of FIGS. 1A & 1B, respectively;

FIGS. 3A and 3B are simplified pictorial illustrations corresponding respectively to FIGS. 1A & 2A, and 1B & 2B, showing various operative regions along the length of each coil;

FIGS. 4A and 4B are simplified pictorial illustrations corresponding respectively to FIGS. 3A and 3B, showing the provision of stripes in some but not all of the operative regions along the length of each coil;

FIG. 5A is a simplified illustration of biofilm buildup in the various operative regions along the length of each coil in the embodiment of FIG. 4A at various phases in time of operation of the system of FIG. 1A;

FIG. 5B is a simplified illustration of biofilm buildup in the two operative regions along the length of each coil in the embodiment of FIG. 4B at various phases in time of operation of the system of FIG. 1B;

FIG. 6A is a simplified illustration of an alternative biofilm-based water treatment system constructed and operative in accordance with an embodiment of the present invention;

FIG. 6B is a simplified pictorial illustration of water and air flows in the embodiment of FIG. 6A;

FIGS. 7A and 7B are each a simplified illustration of a different example of another clogging resistant biofilm-based water treatment system constructed and operative in accordance with an embodiment of the present invention;

FIGS. 8A and 8B are simplified pictorial illustrations of water and air flows in the embodiments of FIGS. 7A & 7B, respectively;

FIG. 9 is a simplified diagram of a system for removal of precipitated chemicals employing a biofilm-based water treatment subsystem, such as that illustrated in FIGS. 6A & 6B;

FIG. 10 is a simplified pictorial illustration of water and air flows in the embodiment of FIG. 9;

FIG. 11 is a simplified illustration of a further alternative clogging resistant biofilm-based water treatment system constructed and operative in accordance with an embodiment of the present invention;

FIG. 12 is a simplified illustration of an additional alternative clogging resistant biofilm-based water treatment system constructed and operative in accordance with an embodiment of the present invention; and

FIG. 13 is a simplified illustration of yet another alternative clogging resistant biofilm-based water treatment system which incorporates a settling pond and an oxidation pond in accordance with an embodiment of the present invention.

### DETAILED DESCRIPTION OF PREFERRED EMBODIMENTS

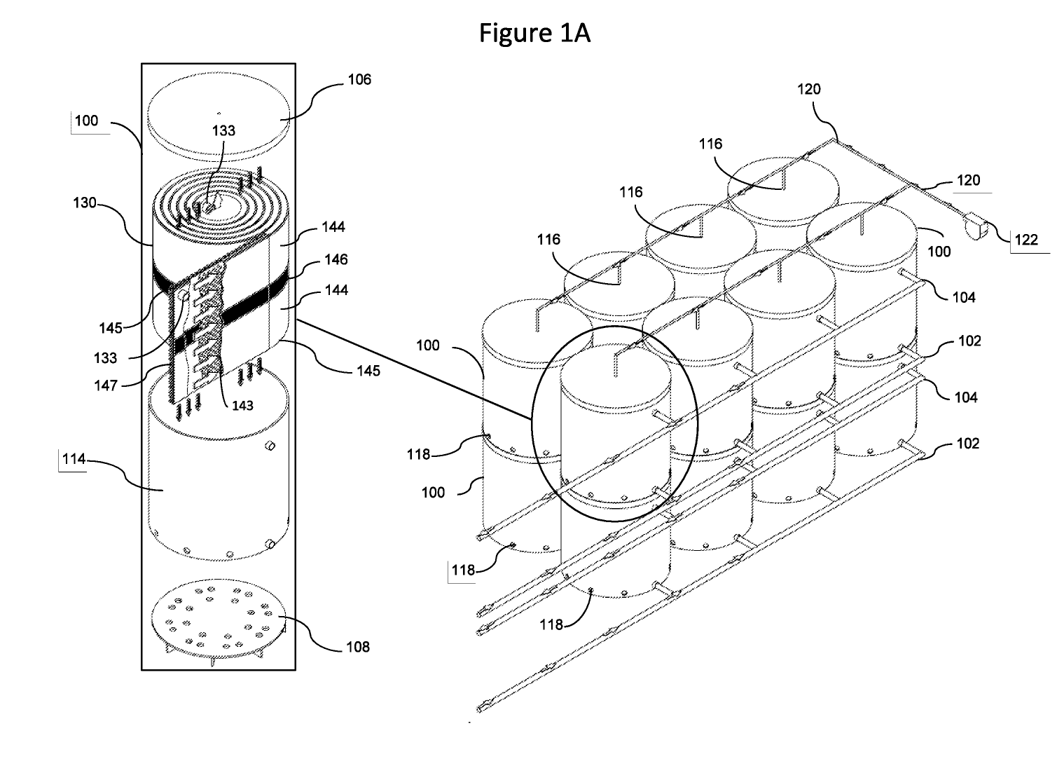

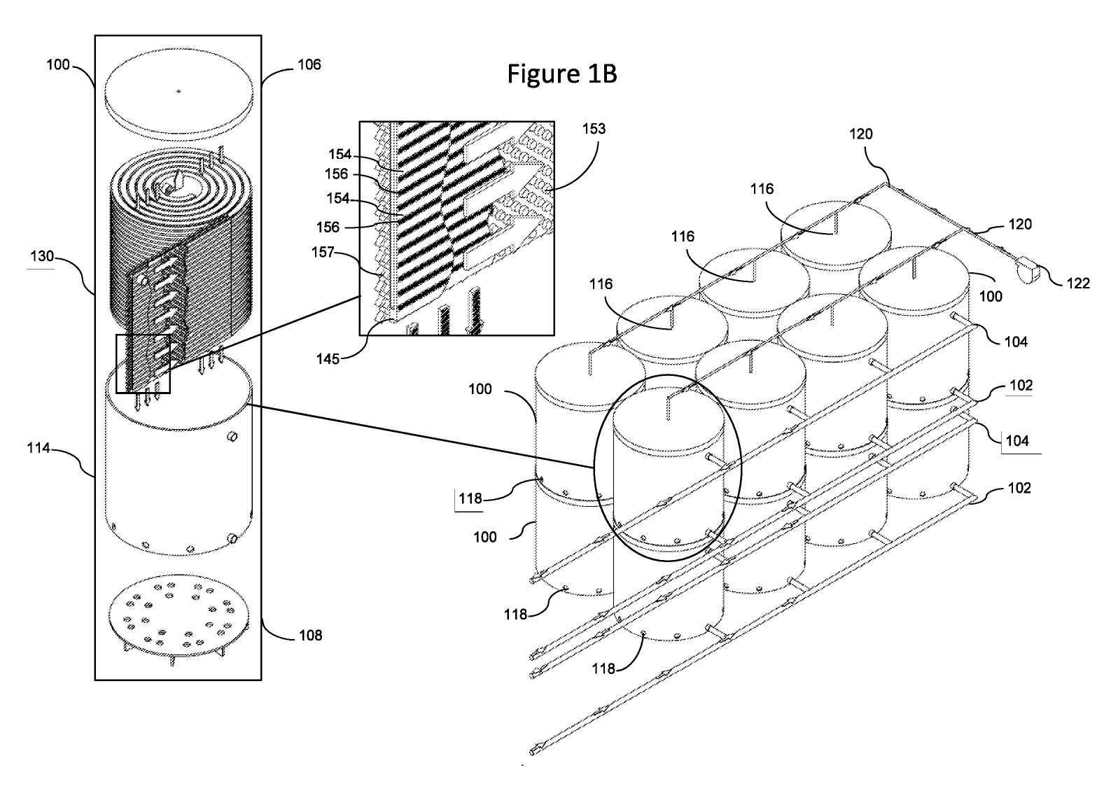

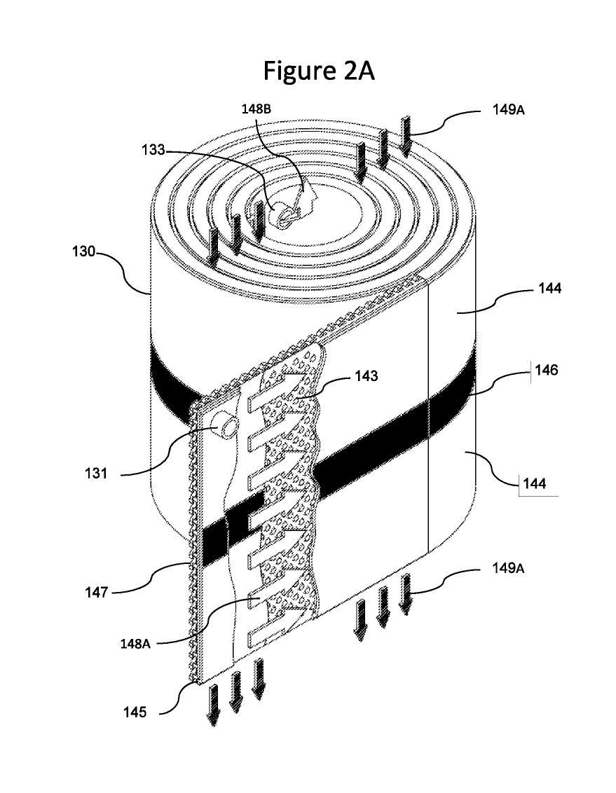

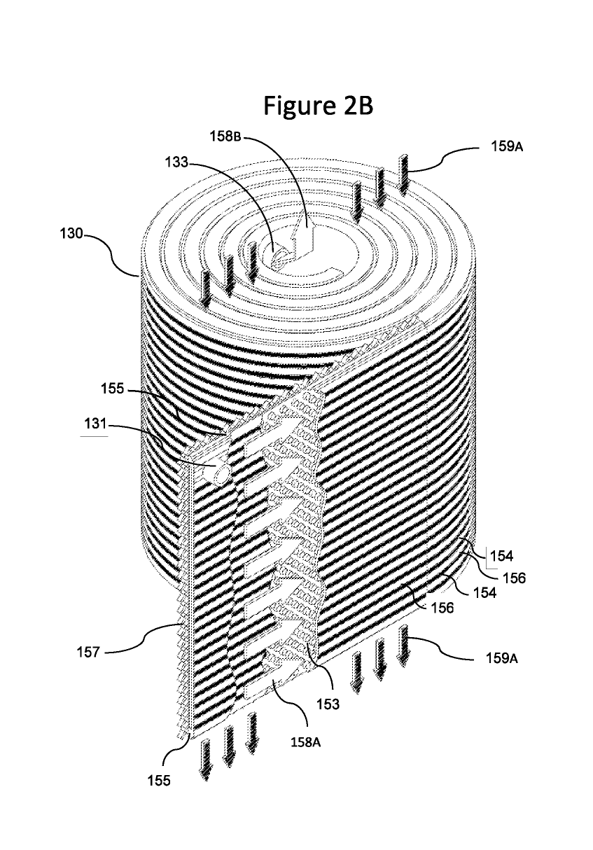

Reference is now made to FIGS. 1A and 1B, which are each a simplified illustration of a clogging resistant biofilm-based water treatment system, constructed and operative in accordance with a preferred embodiment of the present invention, and to FIGS. 2A and 2B, which are simplified pictorial illustrations of water and air flows in the embodiments of FIGS. 1A and 1B, respectively.

In each of FIGS. 1A and, 1B, there are provided a plurality of clogging resistant biofilm-based water treatment modules 100 which are preferably connected in parallel via an inlet manifold 102 to a source (not shown) of water to be treated and are preferably connected in parallel via an outlet manifold 104 to a treated water utilization facility (not shown).

As seen in each of FIGS. 1A and 1B, each of the plurality of clogging resistant biofilm-based water treatment modules 100 preferably includes a generally cylindrical enclosure having a top cover 106 and a bottom 108 and a cylindrical wall 114. Top cover 106 is preferably formed with at least one top aperture 116 which serves as an air inlet, and bottom 108 is preferably formed with circumferentially distributed bottom apertures 118, which serve as air outlets.

In accordance with a preferred embodiment of the present invention, air circulation is provided through the interior of module 100 by means of conduits 120 connecting air flow generator such as a blower or a fan 122 to top apertures 116. The air is provided to top apertures 116, flows through the interior of module 100 and is discharged or vented through circumferentially distributed bottom apertures 118.

It is a particular feature of the invention that circulation may be provided without the need for conduits 120 and air flow generator 122, by means of a naturally occurring air flow resulting from temperature differences between the temperature of the water being treated and the ambient air within modules 100. It is appreciated that in this case, top apertures 116 in top cover 106 may be replaced by circumferentially distributed apertures formed in cylindrical wall 114. If, for example, the ambient air is hotter than the water being treated, a downward air flow will take place from circumferentially distributed top apertures (not shown) to circumferentially distributed bottom apertures 118 and if the ambient air is cooler than the water being treated, an upward air flow will take place from circumferentially distributed bottom apertures 118 to circumferentially distributed top apertures (not shown).

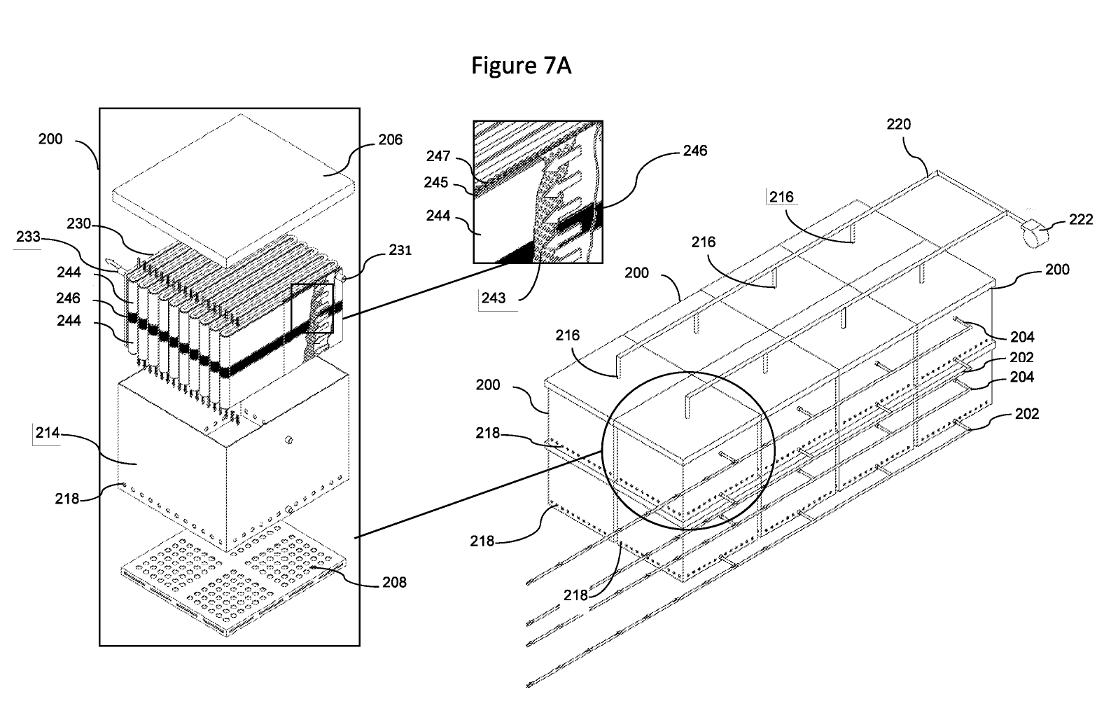

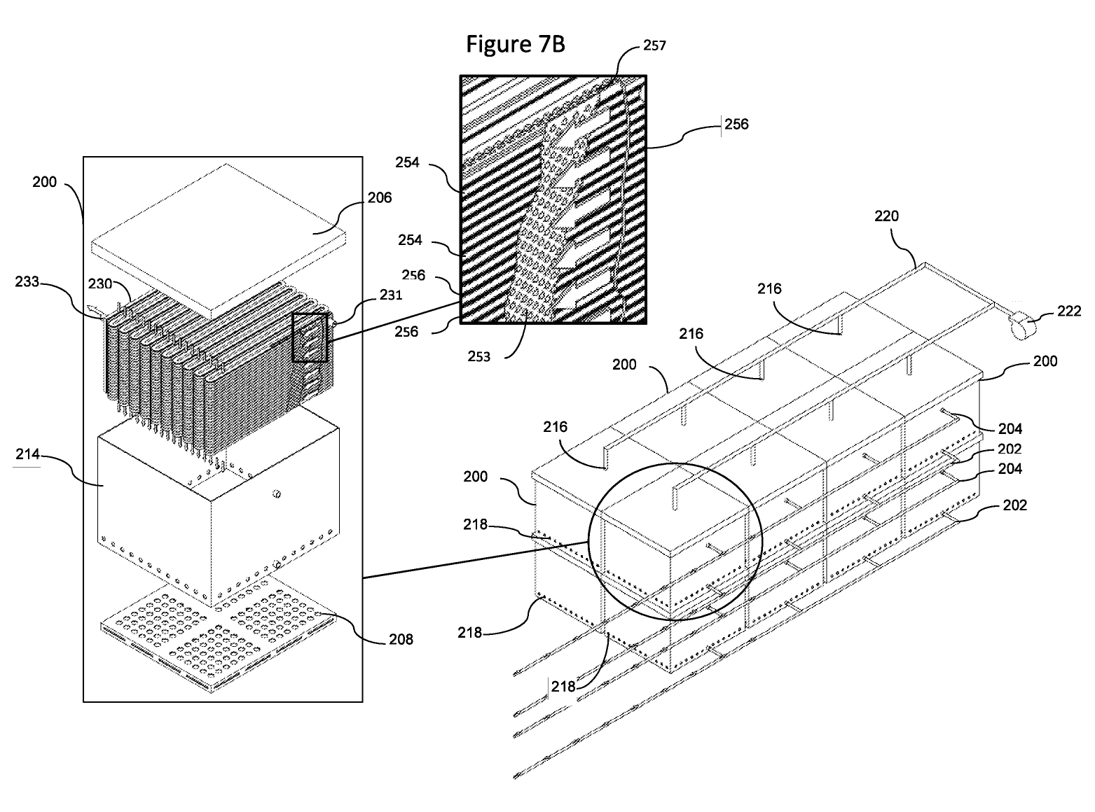

Alternatively, as described hereinbelow with reference to FIGS. 7A and 7B, each of the plurality of clogging resistant biofilm-based water treatment modules can include a generally cubical enclosure. The function of the embodiment that is shown in FIGS. 7A and 7B is similar to that of the cylindrical embodiment that is shown in FIGS. 1A and 1B.

In accordance with a preferred embodiment of the present invention, each of modules 100 includes a membrane-enclosed water flow pathway 130 including at least one water-impermeable, oxygen-permeable membrane wall portion 144 extending along the pathway and at least another wall portion extending along at least part of the pathway 130, wherein biofilm growth and consequent clogging generally takes place along the water-impermeable, oxygen-permeable membrane wall portion and biofilm growth and clogging does not take place along the other wall portion. An entrance 131 of the water flow pathway 130 is coupled to inlet manifold 102. An exit 133 of the water flow pathway is coupled to outlet manifold 104.

Turning specifically to FIG. 1A, it is seen that the membrane-enclosed water flow pathway 130 is shaped as a sleeve and arranged in a coil which encloses a spacer 143. The coiled sleeve is defined by a coiled pair of water-impermeable, oxygen-permeable membrane wall portions 144 each of which includes a strip 146 which is oxygen-impermeable. Strips 146 on spaced generally upstanding wall portions 144 are generally aligned to be opposite one another. The wall portions 144 are longitudinally sealed to each other along their top and bottom ends 145.

Preferably, water impermeable oxygen-permeable membrane wall portions 144 comprise a fabric formed of a first polymer, extrusion coated with a second polymer. The coating is preferably applied to the water facing side of the fabric and typically has a thickness of between 5 and 20 microns. Preferably, the first polymer is a dense polyolefin, such as polyethylene or polypropylene, or a polyester. In a preferred embodiment of the water-impermeable, oxygen permeable membrane the fabric formed of a first polymer is a non-woven fabric, such as Tyvek®, commercially available from Dupont. In one embodiment of the water impermeable oxygen-permeable membrane wall portions 144, the second polymer is an alkyl-acrylate. The function of the second polymer coating is to substantially seal the fabric formed of a first polymer to passage of water with a small additional resistance to oxygen passage by diffusion therethrough. It is noted that alkyl-acrylates are compatible with polyolefin fabrics and specifically polyethylene fabrics for coating by extrusion. Alternatively, the second polymer is poly-methyl-pentene, which is compatible with polyester fabrics for coating by extrusion.

Strip 146 preferably extends along at least the part of the water flow pathway 130 wherein buildup of a thick biofilm normally takes place. Strip 146 may extend further along the water flow pathway in order to enable reversing the flow direction or increasing the feed rate or in order to deal with an unexpected increase in organic material load passing through the water flow pathway.

Preferably, strip 146 has an oxygen permeability which is lower by more than one order of magnitude than that of oxygen-permeable membrane wall portion 144. Strip 146 may be realized, for example by coating a corresponding strip of the water-impermeable, oxygen-permeable membrane wall portion 144 with an oxygen-impermeable material, such as a contact adhesive, ink, drying adhesive, hot adhesive. Strip 146 alternatively may be in the form of a strip of a generally low permeability polymer such as polyethylene or polypropylene, heat laminated onto oxygen-permeable membrane wall portion 144 or arranged on oxygen-permeable membrane wall portion 144 and held thereon by coiling of the sleeve.

Strip 146 may be made of a pressure sensitive tape such as duct tape. It should be noted that strip 146 should be chosen to be adhesive or adherent to water-impermeable, oxygen-permeable membrane wall portion 144.

It is further noted that oxygen impermeable strip 146 may be applied on either or both of the water side and the air side of oxygen permeable wall portion 144. The choice of the side on which to apply the non-permeable material is generally made based on production process considerations.

Preferably an additional spacer 147 is coiled outside of and together with pathway 130. Coiled spacer 143 is typically a plastic netting or dimpled sheet, which maintains a spacing between adjacent inside walls of pathway 130, thus allowing water movement between adjacent wall surfaces of the coiled membrane-enclosed water flow pathway 130. Similarly, coiled spacer 147 is typically a plastic netting or dimpled sheet, which maintains a spacing between adjacent outside walls of pathway 130, thus allowing air movement between adjacent outside wall surfaces of the coiled membrane-enclosed water flow pathway 130.

The nettings for either of spacers 143 and 147 are preferably bi-planar- or tri-planar. The dimpled sheets for either of spacers 143 and 147 can include one sided or double sided dimples. The thickness of spacers 143 and 147 can be between approximately 1-20 mm and most preferably is between 5-10 mm Spacers 143 and 147 are made of a water durable material having a compressive strength of above 2 ton/m², most preferably above 20 ton/m². Preferably the material is suitable for coiling at a diameter of at least 200 mm Preferred materials for the spacers include plastic materials such as polyethylene, polyethylene terephthalate (PET), polypropylene, polyamide and polyacetal. Spacers 143 and 147 may be identical, similar or dissimilar.

The water inlet and outlet flows in the embodiment of FIG. 1A are shown in FIG. 2A by arrows 148A and 148B respectively. The air inlet and outlet flows in the embodiment of FIG. 1A are shown in FIG. 2A by arrows 149A and 149B respectively. It is appreciated that flow direction of either the water or the air could be in the opposite direction to what is shown by arrows 148A and 148B, and arrows 149A and 149B.

Turning specifically to FIG. 1B, it is seen that the membrane-enclosed water flow pathway 130 is shaped as a sleeve and arranged in a coil which encloses a spacer 153. The coiled pathway 130 is formed primarily by a water-impermeable, oxygen-permeable membrane wall portion 154 and includes a plurality of generally parallel coiled strips 156, seen more clearly in FIG. 2B, which are oxygen-impermeable. Strips 156 preferably extend along at least a part of the water flow pathway 130 wherein thick biofilm growth normally takes place and may extend further along the water flow pathway.

Preferably, strips 156 have an oxygen permeability which is lower than that of oxygen-permeable membrane wall portion 154 by more than one order of magnitude. Strips 156 may be realized, for example by coating a corresponding strip of the water-impermeable, oxygen-permeable membrane wall portion 154 with an oxygen-impermeable material, such as a contact adhesive, ink, drying adhesive, hot adhesive. Strip 156 alternatively may be in the form of a strip of a generally low permeability polymer such as polyethylene or polypropylene, heat laminated onto oxygen-permeable membrane wall portion 154 or arranged on oxygen-permeable membrane wall portion 154 and held thereon by coiling of the sleeve.

Strips 156 may be made of a pressure sensitive tape such as duct tape. It should be noted that strips 156 should be chosen to be adhesive or adherent to water-impermeable, oxygen-permeable membrane wall portion 154.

It is further noted that oxygen impermeable strips 156 may be applied on either or both of the water side and the air side of oxygen permeable wall portion 154. The choice of the side on which to apply the non-permeable material is generally made based on production process considerations.

Preferably an additional spacer 157 is coiled outside of and together with pathway 130. Coiled spacer 153 is typically a plastic netting or dimpled sheet, which maintains a spacing between adjacent inside walls of pathway 130, thus allowing water movement between adjacent wall surfaces of the coiled membrane-enclosed water flow pathway 130. Similarly, coiled spacer 157 is typically a plastic netting or dimpled sheet, which maintains a spacing between adjacent outside walls of pathway 130, thus allowing air movement between adjacent outside wall surfaces of the coiled membrane-enclosed water flow pathway 130.

The nettings for either of spacers 153 and 157 are preferably bi-planar- or tri-planar. The dimpled sheets for either of spacers 153 and 157 can include one sided or double sided dimples. The thickness of spacers 153 and 157 can be between approximately 1-20 mm and most preferably is between 5-10 mm. Spacers 153 and 157 are made of a water durable material having a compressive strength of above 2 ton/m², most preferably above 20 ton/m². Preferably the material is suitable for coiling at a diameter of at least 200 mm Preferred materials for the spacers include plastic materials such as polyethylene, polyethylene terephthalate (PET), polypropylene, polyamide and polyacetal. Spacers 153 and 157 may be identical, similar or dissimilar.

The water inlet and outlet flows in the embodiment of FIG. 1B are shown in FIG. 2B by arrows 158A and 158B. The air inlet and outlet flows in the embodiment of FIG. 1B are shown in FIG. 2B by arrows 159A and 159B respectively. It is appreciated that flow direction of any of the water and air could be in the opposite direction to what is shown by arrows 158A and 158B, and arrow 159A and 159B.

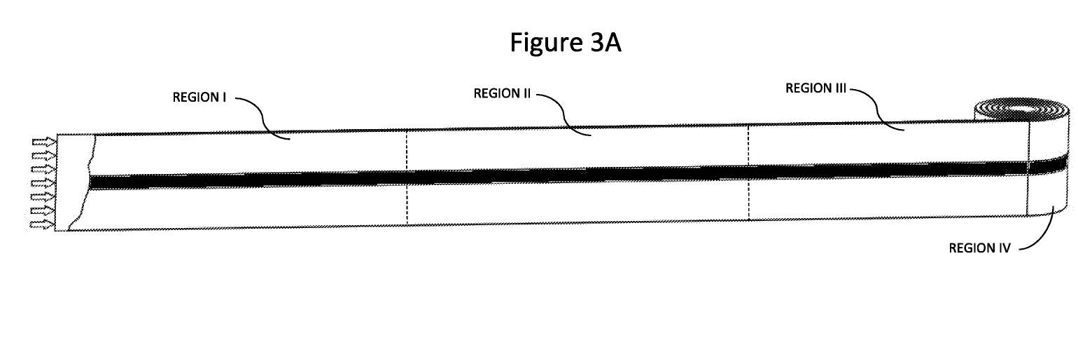

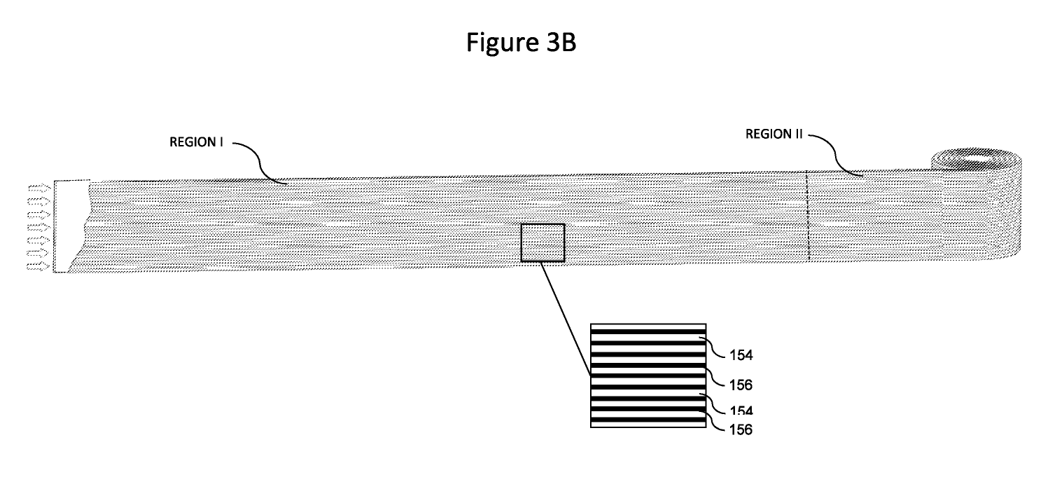

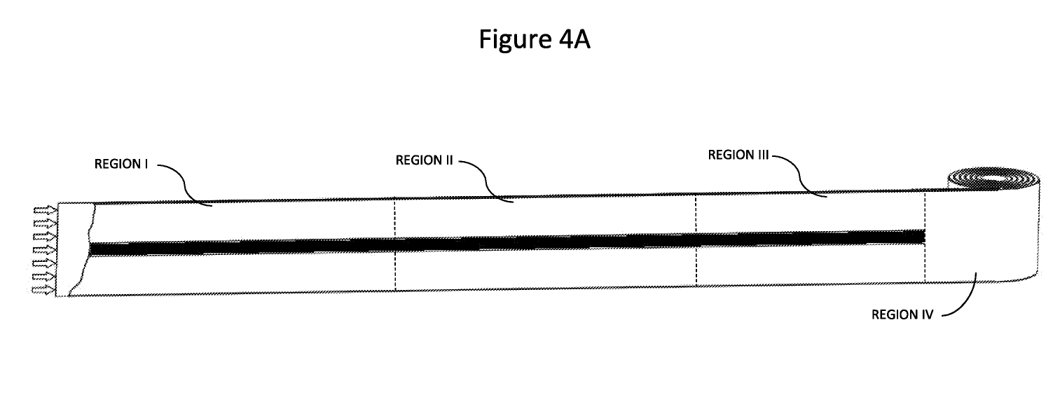

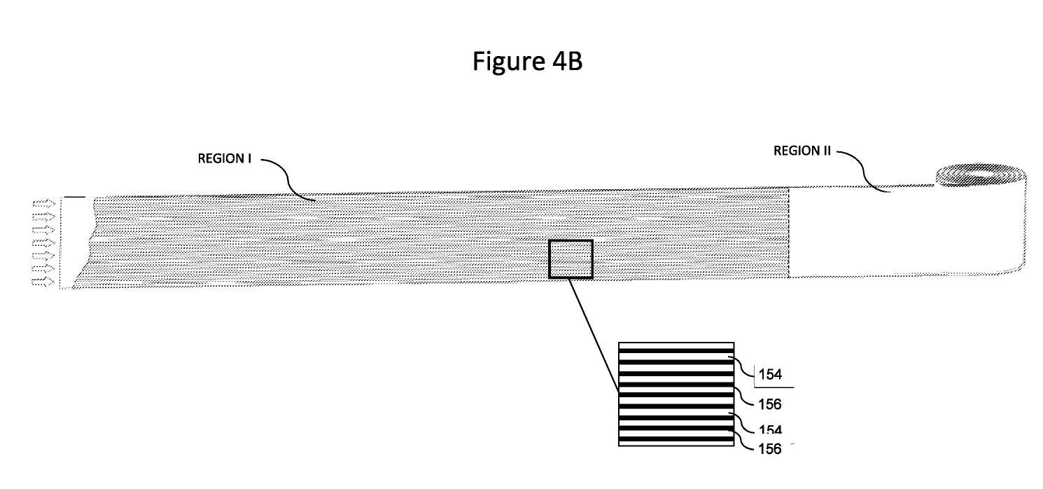

Reference is now made to FIGS. 3A and 3B, which are simplified pictorial illustrations respectively corresponding to FIGS. 1A & 2A and 1B & 2B, showing various operative regions along the length of each coil. It will be appreciated from the following description that the entire length of each coiled water flow pathway may be considered as being divided into a series of operative regions having different biofilm growth characteristics. In the embodiments shown in FIGS. 3A and 4A, these regions are designated by Roman numerals I, II, III and IV. In the embodiments shown in FIGS. 3B and 4B these regions are designated by Roman numerals I and II.

Reference is now made to FIGS. 4A and 4B, which are simplified pictorial illustrations corresponding to FIGS. 3A and 3B, showing provision of strips in some but not all of the operative regions along the length of each coil. As will be described herein below in detail, in accordance with a preferred embodiment of the present invention, in the embodiments of FIGS. 4A and 4B, the strips of the oxygen impermeable wall portion may be present only in the upstream regions. More specifically, in the embodiment presented in FIG. 4A, the strips of the oxygen impermeable wall portion may be present in regions I, II and III but are not typically present in region IV, since thick biofilm growth will not normally occur in region IV.

In the embodiment presented in FIG. 4B, the strips 156 of the oxygen impermeable wall portion are present in region I but are not typically present in region II, since thick biofilm growth will not normally occur in region II. It is appreciated that in the embodiment shown in FIG. 4B, impermeable wall portion 156 in region I is operative to prevent clogging of the flow pathway, whereas in region II oxygen permeability is not decreased by provision of an impermeable wall portion.

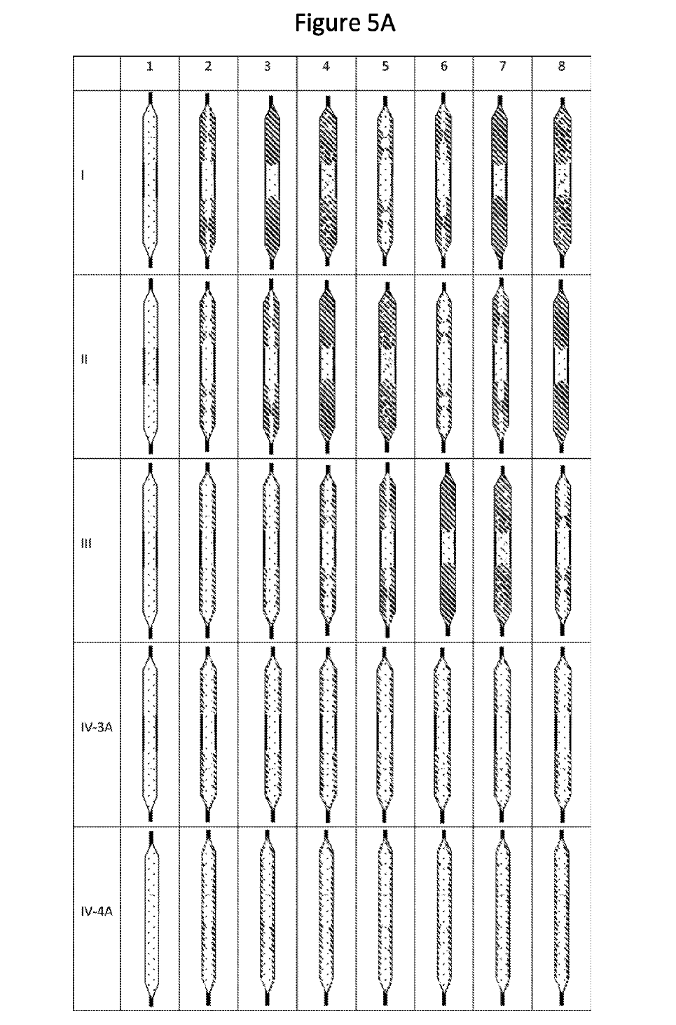

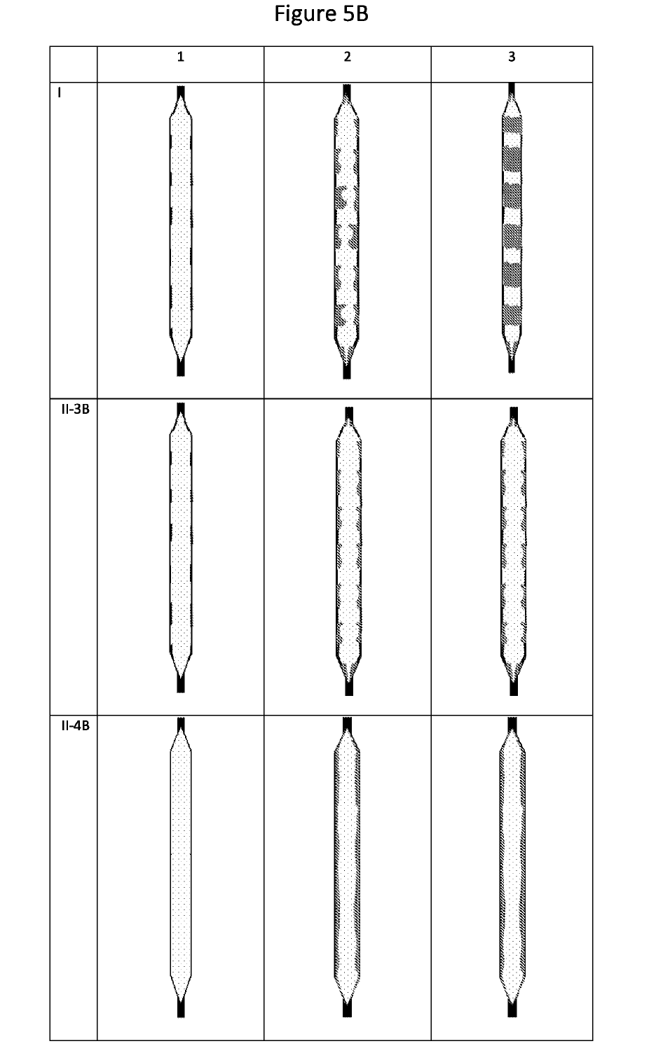

Reference is now made to FIG. 5A, which is a simplified illustration of biofilm buildup in the various operative regions along the length of each flow path 130 in the embodiment of FIG. 4A at various phases of operation of the system of FIG. 1A.

FIG. 5A is organized as follows: From left to right, there are provided columns, numbered 1-8, which represent eight operational phases, here sequentially designated as Phases 1-8, which are consecutive in time but are not necessarily of equal time duration. In each column biofilm buildup is illustrated in sequential regions designated I, II, III and IV along the flow path, e.g. along the length of each coil in the embodiment of FIGS. 1A, 2A, 3A and 4A. The difference between the embodiments that are presented in FIG. 3A and FIG. 4A is in the region designated IV, and therefore FIG. 5A presents the two alternative embodiments as IV-3A and IV-4A.

It is to be appreciated that FIG. 5A does not represent any specific sequence of events but rather is presented to provide an understanding of the biofilm buildup and disintegration mechanism that generally takes place in the embodiment of FIGS. 1A, 2A and 3A. It is noted that the illustrations are not to scale.

Table I below presents examples of dimensions of full scale embodiments of the present invention as described hereinabove with reference to FIGS. 1A-5B.

TABLE I

| Parameter | Example 1 | Example 2 |
|---|---|---|
| Water space type | Geotechnical | Geotechnical |
| | netting | dimple sheet |
| Water spacer thickness | 5-10 mm | 6-10 mm |

| | |
|---|---|
| Water flow path height | 800-1000 mm |
| Water flow path length | 50-100 m |

| | | |
|---|---|---|
| Air spacer type | 2 layers of | 1 layer of |
| | geotechnical | geotechnical |
| | netting | netting |
| Air spacer thickness | 2.5-5 mm each | 4-6 mm |

| | |
|---|---|
| Non permeable wall | 10-20% |
| portion percent of total | |

It is seen from a consideration of FIG. 5A that initially, at a phase designated as Phase 1, all of regions I, II, III and IV are generally free from biofilm buildup. At a phase designated Phase 2, upon supply of water to be treated to membrane-enclosed water flow pathway 130 via inlet manifold 102, it is seen that in region I there is buildup of a biofilm along the interior surfaces of walls 144 except along strips 146. Similarly, there is a buildup of a biofilm in region II along the interior surfaces of walls 144 except along strips 146. However, the biofilm buildup in region II is slower because a major part of the organic material in the water is consumed by the biofilm in region I, and therefore the water that reaches region II comprises a lower load of organic material. However at Phase 2 in regions III and IV there is hardly any biofilm buildup relative to the biofilm buildup in regions I and II, because relatively small amounts of organic matter, required to sustain biofilm buildup reach regions III and IV at Phase 2, since they are depleted in regions I and II.

For settled municipal wastewater in a moderate climate, typically Phase 2 extends for one to three months from the initial supply of water to be treated to the pathway 130. In regions III and IV nitrification takes place, and removal of organic material is generally at rate smaller than or equal to the endogenous decay rate of the biofilm microbiological population.

At a phase designated as Phase 3, the biofilm growth is such that in region I, the entire pathway 130, other than the portion thereof bounded by oxygen-impermeable strips 146 is blocked. Once this occurs, the rate of biofilm buildup in region II increases, due to the fact that an increasing amount of organic material in the water reaches region II. As a consequence, region III also receives a higher organic material loading than in Phase 2 similar to the organic material load that region II received during Phase 2.

For settled municipal wastewater in a moderate climate, typically Phase 3 is reached within 2-4 months from the beginning of Phase 2.

In region IV the buildup is significantly slower than in regions II and III. The reason for this is that most of the organic material in the water to be treated is already depleted by passing through upstream regions II and III, and does not reach region IV, wherein the remaining organic material, load is only sufficient to support the endogenous decay rate of a thin biofilm.

At Phase 4, the biofilm growth is such that in region II, the entire pathway 130, other than the portion bounded by oxygen-impermeable strips 146 is blocked by the biofilm.

Importantly, at Phase 4, this blockage prevents the flow of water, which contains the organic material, from reaching most of the biofilm and therefore the lack of organic material, sufficient to support the biofilm in region I, causes the biofilm in region I to decay and disintegrate, while significant biofilm buildup continues at regions II and III other than along oxygen-impermeable strips 146. Disintegration typically takes several weeks to one month in moderate climates. The water to be treated passes through region I between strips 146 and substantially all of the organic material reaches regions II and III.

Once all of the pathway 130 along region II is blocked other than that portion thereof bordered by oxygen-impermeable strips 146, significant biofilm buildup begins at region III other than along oxygen-impermeable strips 146, due to the fact that an increasing amount of organic material in the water reaches region III. In region IV the buildup remains generally the same as in Phases 2 and 3, which is a generally steady state level at which the passageway 130 does not become blocked.

In a moderate climate, typically Phase 4 extends for about one month from the end of Phase 3. During Phase 4, in region IV the biofilm buildup is significantly slower than in regions II and III. The reason for this is that most of the organic material in the water to be treated is already depleted in region II and III and does not reach region IV wherein the remaining organic material load is only sufficient to support the endogenous decay rate of a thin biofilm.

At a phase designated as Phase 5, the lack of organic material in region I, causes the biofilm to fully disintegrate, while the lack of organic material to support biofilm growth in region II causes the biofilm in region II to begin to decay and disintegrate, while significant biofilm growth continues at region III and is renewed in region I, upon completion of disintegration of the previously built up biofilm other than along oxygen-impermeable strips 146 thereat. Disintegration typically takes several weeks to one month in moderate climates. Water to be treated bypasses region II between strips 146 and substantially all of the organic material reaches regions III and IV.

Typically Phase 5 covers up to one month from the end of Phase 4. In region IV. During Phase 5, in region IV the biofilm buildup is significantly slower than in regions I and III. The reason for this is that most of the organic material in the water to be treated is already depleted in region I and III and does not reach region IV, wherein the remaining organic material load is only sufficient to support the endogenous decay rate of a thin biofilm.

At a phase designated Phase 6, it is seen that in region I there is an increased buildup of biofilm along the interior surfaces of walls 144 except along strips 146, while in region II the biofilm continues to disintegrate due to lack of organic material. Significant biofilm growth continues at region III other than along oxygen-impermeable strips 146, causing all of the pathway 130 at Region III to become blocked other than that portion thereof bordered by oxygen-impermeable strips 146. Once all of the pathway 130 in Region III is blocked other than that portion thereof bordered by oxygen-impermeable strips 146, significant biofilm growth appears at regions I and II other than along oxygen-impermeable strips 146. Typically Phase 6 covers one to two months from the end of phase 5.

At a phase designated Phase 7, it is seen that in region I there is an further buildup of biofilm along the interior surfaces of walls 144 except along strips 146. Once the entire pathway 130 in region I is blocked other than that portion thereof bordered by oxygen-impermeable strips 146, significant biofilm buildup occurs at region II other than along oxygen-impermeable strips 146. In region III, the biofilm is seen to disintegrate due to lack of organic material and biofilm buildup is renewed upon completion of disintegration of the previously built up biofilm other than along oxygen-impermeable strips 146 thereat.

Typically Phase 7 covers one to two months from the end of phase 6.

At a phase designated Phase 8, it is seen that in region II there is a further buildup of biofilm along the interior surfaces of walls 144 except along strips 146. Once the entire pathway 130 in region II, other than that portion thereof bordered by oxygen-impermeable strips 146, is blocked, significant biofilm buildup occurs at region III other than along oxygen-impermeable strips 146. In region I, the biofilm is seen to disintegrate due to lack of organic material and biofilm buildup is renewed, other than along oxygen-impermeable strips 146, upon completion of disintegration of the previously built up biofilm, and region IV the buildup biofilm remains at a steady state level. Typically Phase 8 covers one to two months from the end of Phase 7.

It is appreciated that the sequential phases described generally hereinabove are repeated throughout operation of the system.

Reference is now made to FIG. 5B, which is a simplified illustration of biofilm buildup in the various operative regions along the length of each flow pathway 130 in the embodiment of FIG. 4B at various phases in time of operation of the system of FIG. 1B.

FIG. 5B is organized as follows: From left to right, there are provided columns, numbered 1-3 which represent three operational phases which are consecutive in time but are not necessarily of equal time duration. In each column biofilm buildup is illustrated in sequential regions designated I and II along the flow path, i.e. along the length of each coil in the embodiment of FIGS. 1B, 2B, 3B and 4B. The difference between the embodiments that are presented in FIG. 3B and FIG. 4B is in the region designated II, and therefore FIG. 5B presents the two alternative embodiments as II-3B and II-4B.

It is to be appreciated that FIG. 5B does not represent any specific sequence of events but rather is presented to provide an understanding of the biofilm buildup mechanism that generally takes place in the embodiment of FIGS. 1B, 2B and 3B. It is noted that the illustrations are not to scale.

It is seen from a consideration of FIG. 5B that initially, at a phase designated as Phase 1, both of regions I and II are generally free from biofilm buildup. At a phase designated Phase 2, upon supply of water to be treated to membrane-enclosed water flow pathway 130 via inlet manifold 102, it is seen that in region I, buildup of a biofilm takes place along the interior surfaces of walls 154 except along strips 156. Similarly, but to a lesser extent, due to slower biofilm growth, buildup of a biofilm takes place in region II for both cases of 3B and 4B, along the interior surfaces of walls 154 except along oxygen impermeable strips 156.

For settled municipal wastewater in a moderate climate, typically Phase 2 covers one to three months from the initial supply of water to be treated to the pathway 130.

At a phase designated as Phase 3, the biofilm growth is such that in region I, the entire pathway 130, other than the portions bounded by oxygen-impermeable strips 156, is blocked.

As distinct from the situation in the embodiment of FIG. 5A, a steady state of a clogged biofilm buildup is maintained in region I. The difference between the embodiment that is presented in FIG. 5A and the embodiment that is presented in FIG. 5B can be explained by the width of the biofilm growth cross-section. The biofilm in the present embodiment develops on the oxygen-permeable membrane wall portions 154 in narrow strips, in between which a plurality of water flow channels are maintained. Therefore, even when there is significant biofilm buildup in region I, organic material is not blocked from reaching most of the biofilm and, as a result, the biofilm continues to function and consume both the organic material from the water, which continues to flow in the portions bounded by oxygen-impermeable strips 156, and oxygen that permeates through the oxygen-permeable membrane wall portions 154.

Accordingly, a greater biofilm buildup does not take place in region II as clogged region I removes most of the load of organic material from the water passing therethrough, thus limiting the amount of organic material reaching region II.

It is appreciated that the sequential phases described generally hereinabove are repeated throughout operation of the system.

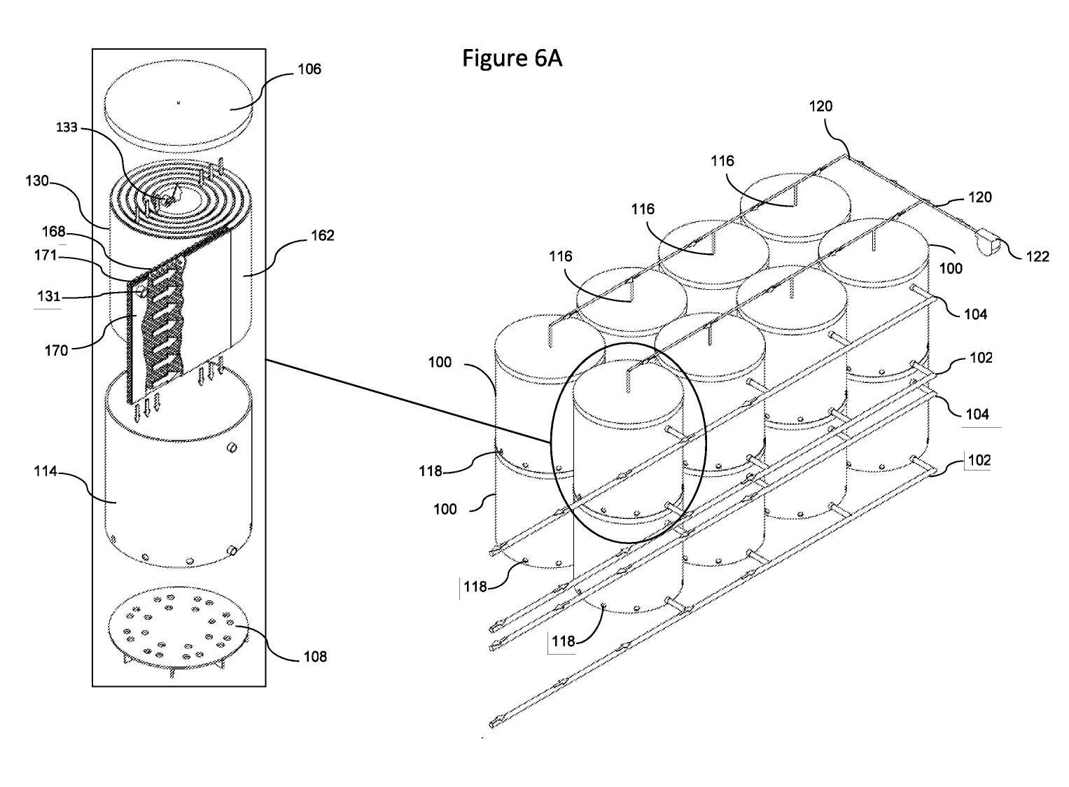

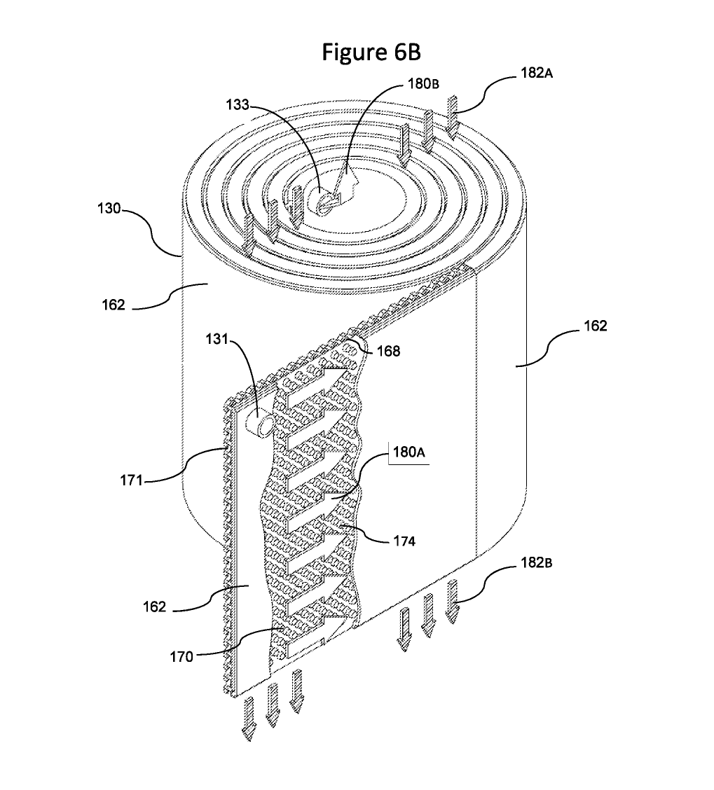

Reference is now made to FIG. 6A, which is a simplified illustration of an alternative biofilm-based water treatment system constructed and operative in accordance with an embodiment of the present invention, and to FIG. 6B, which is a simplified pictorial illustration of water and air flows in the embodiment of FIG. 6A.

As seen in FIGS. 6A and 6B, the membrane-enclosed water flow pathway 130 in the embodiment of FIGS. 6A & 6B includes a coil structure 160 constructed as follows:

A first layer 162 is in the form of a water-impermeable, oxygen-permeable membrane wall portion having an inside surface (not shown) and an outside surface 166. A second layer 168 is in the form of a water-impermeable wall portion having an inside surface 170 and an outside surface 171, which is sealed to the first layer 162 along at least part of its periphery, thereby to define the spacing for at least part of the water flow pathway 130.

Outside surface 171 of second layer 168 is shaped to define air-flow pathways between the outside surface 166 of the first layer 162 and an adjacent surface of the coiled second layer and preferably includes an array of mutually parallel elongate protrusions 172. Inside surface 170 of second layer 168 is shaped to define a water-flow pathway between the inside surface of first layer 162 and an adjacent inside surface 170 of the coiled second layer and preferably include a plurality of dispersed dimples 174.

The water inlet and outlet flows in the embodiment of FIG. 6A are designated in FIG. 6B by respective arrows 180A and 180B. The air inlet and outlet flows in the embodiment of FIG. 6A are designated in FIG. 6B by arrows 182A and 182B respectively. It is appreciated that the flow direction of either or both of the water and air flows could in the opposite directions to that which is shown in FIG. 6B.

The mutually parallel elongate protrusions 172 can have a height of between approximately 1-20 mm in thickness and most preferably between 2-8 mm. The plurality of dispersed dimples 174 can have a height of between approximately 4-20 mm in thickness and most preferably between 4-10 mm.

Preferably the second layer 168 is formed of a material, which is suitable for coiling up at a diameter of at least 250 mm Preferred materials for the second layer 168 include plastic materials such as polyethylene, polyethylene terephthalate (PET), polypropylene, polyamide and polyacetal.

Reference is now made to FIGS. 7A and 7B, which are simplified illustrations of other alternative biofilm-based water treatment systems constructed and operative in accordance with an embodiment of the present invention.

It is to be appreciated that the embodiment of FIGS. 7A and 7B is generally similar to that described hereinabove with reference to FIGS. 1A and 1B with the difference being in the configuration of the membrane-enclosed water flow pathway. In FIGS. 1A & 1B described hereinabove, membrane-enclosed water flow pathway 130 is spirally wound, whereas the corresponding membrane-enclosed water flow pathway in the embodiment of FIGS. 7A & 7B is an undulating pathway. The function of the membrane-enclosed water flow pathways in both embodiments are generally the same and the variations and operations described above in FIGS. 2A-6B, also are applicable, where suitable to the embodiment of FIGS. 7A & 7B.

As seen in FIGS. 7A and 7B, there are provided a plurality of clogging resistant biofilm-based water treatment modules 200 which are preferably connected in parallel via an inlet manifold 202 to a source (not shown) of water to be treated and are preferably connected in parallel via an outlet manifold 204 to a treated water utilization facility (not shown).

As seen in each of FIGS. 7A and 7B, each of the plurality of clogging resistant biofilm-based water treatment modules 200 preferably includes a generally cubical enclosure 210 having a top cover 206 and a bottom 208 and a circumferential wall 214, which is preferably formed with top apertures 216 which serve as air inlets and circumferentially distributed bottom apertures 218 which serve as air outlets.

In accordance with a preferred embodiment of the present invention, air circulation is provided through the interior of cubical enclosure 210 by means of conduits 220 coupled to top apertures 216 and to circumferentially distributed bottom apertures 218 and which provide a flow of air from an air flow generator 222, such as a fan.

It is a particular feature of the invention that circulation may be provided without the need for conduits 220 and air flow generator 222, by means of a naturally occurring air flow resulting from temperature differences between the temperature of the water being treated and the ambient air within modules 200. It is appreciated that in this case, top apertures 216 in top cover 206 may be replaced by circumferentially distributed apertures formed in circumferential wall 214. If, for example, the ambient air is hotter than the water being treated, a downward air flow will take place from circumferentially distributed top apertures (not shown) to circumferentially distributed bottom apertures 218 and if the ambient air is cooler than the water being treated, an upward air flow will take place from circumferentially distributed bottom apertures 218 to circumferentially distributed top apertures (not shown).

In accordance with a preferred embodiment of the present invention, each of modules 200 includes a membrane-enclosed water flow pathway 230 including at least one water-impermeable, oxygen-permeable membrane wall portion extending along the pathway and at least another wall portion extending along at least part of the pathway 230, wherein biofilm growth and consequent clogging generally takes place along the water-impermeable, oxygen-permeable membrane wall portion and biofilm growth and clogging does not take place along the other wall portion. An entrance 231 of the water flow pathway 230 is coupled to inlet manifold 202 and an exit 233 of the water flow pathway is coupled to outlet manifold 204.

Turning specifically to FIG. 7A, it is seen that the membrane-enclosed water flow pathway 230 is shaped as a sleeve and arranged in back and forth folded configuration. Pathway 230 encloses an similarly back and forth folded spacer 243. The water flow pathway 230 is preferably defined by a pair of back and forth folded water-impermeable, oxygen-permeable membrane wall portions 244, each of which includes a strip 246 which is oxygen-impermeable. Strips 246 on spaced generally upstanding wall portions 244 are generally aligned to be opposite one another. The wall portions 244 are longitudinally sealed to each other along their top and bottom ends 245.

Strip 246 preferably extends along at least the part of the water flow pathway 230 wherein buildup of a thick biofilm normally takes place. Strip 246 may extend further along the water flow pathway in order to enable reversing the flow direction or increasing the feed rate or in order to deal with an unexpected increase in organic material load passing through the water flow pathway process performance.

Preferably, strip 246 has an oxygen permeability which is lower by more than one order of magnitude than that of oxygen-permeable membrane wall portion 244. Strip 246 may be realized, for example by coating a corresponding strip of the water-impermeable, oxygen-permeable membrane wall portion 244 with an oxygen-impermeable material, such as a contact adhesive, ink, drying adhesive, hot adhesive. Strip 246 alternatively may be in the form of a strip of a generally low permeability polymer such as polyethylene or polypropylene, heat laminated onto oxygen-permeable membrane wall portion 244 or arranged on oxygen-permeable membrane wall portion 244 and held thereon by folding of the sleeve.

Strip 246 may be made of a pressure sensitive tape such as duct tape. It should be noted that strip 246 should be chosen to be adhesive or adherent to water-impermeable, oxygen-permeable membrane wall portion 244.

It is further noted that oxygen impermeable strip 246 may be applied on either or both of the water side and the air side of oxygen permeable wall portion 244. The choice of the side on which to apply the non-permeable material is generally made based on production process considerations.

Preferably an additional spacer 247 is provided outside of and folded together with pathway 230. Spacer 243 is typically a plastic netting or dimpled sheet, which maintains a spacing between adjacent inside walls of pathway 230, thus allowing water movement between adjacent wall surfaces of the membrane-enclosed water flow pathway 230. Similarly, spacer 247 is typically a plastic netting or dimpled sheet, which maintains a spacing between adjacent outside walls of pathway 230, thus allowing air movement between adjacent outside wall surfaces of the folded membrane-enclosed water flow pathway 230.

The nettings for either of spacers 243 and 247 are preferably bi-planar- or tri-planar. The dimpled sheets for either of spacers 243 and 247 can include one sided or double sided dimples. The thickness of spacers 243 and 247 can be between approximately 1-20 mm and most preferably is between 5-10 mm Spacers 243 and 247 are made of a water durable material having a compressive strength of above 2 ton/m², most preferably above 20 ton/m². Preferably the material is suitable for folding at a diameter of at least 2 inches. Preferred materials for the spacers include plastic materials such as polyethylene, polyethylene terephthalate (PET), polypropylene, polyamide and polyacetal. Spacers 243 and 247 may be identical, similar or dissimilar.

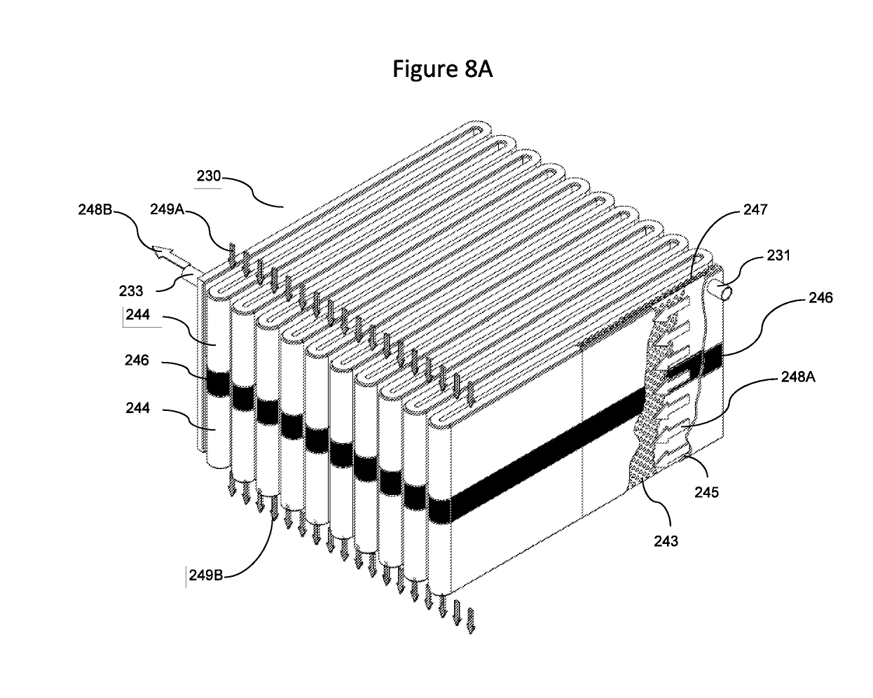

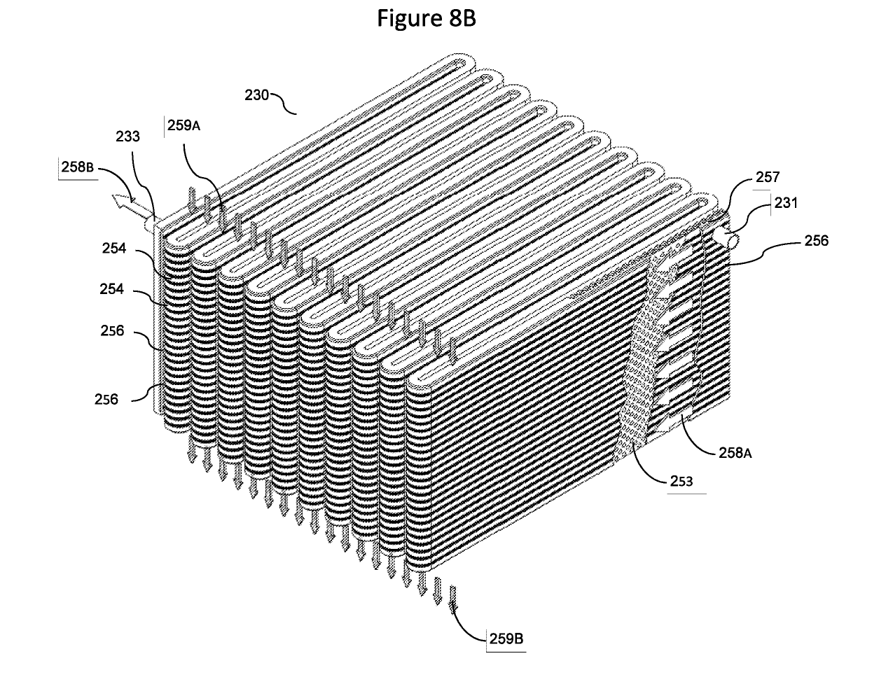

The water inlet and outlet flows in the embodiment of FIG. 7A are shown in FIG. 8A by arrows 248A and 248B respectively. The air inlet and outlet flows in the embodiment of FIG. 7A are shown in FIG. 8A by arrows 249A and 249B respectively. It is appreciated that flow direction of either the water or the air could be in the opposite direction to what is shown by arrows 248A and 248B, and arrows 249A and 249B.

Turning specifically to FIG. 7B, it is seen that the membrane-enclosed water flow pathway 230 is shaped as a sleeve and arranged back and forth folded arrangement, which encloses a spacer 253. The folded pathway 230 is formed primarily by a water-impermeable, oxygen-permeable membrane wall portion 254 and includes a plurality of generally parallel strips 256, seen more clearly in FIG. 8B, which are oxygen-impermeable. Strips 256 preferably extend along at least a part of the water flow pathway 230 wherein thick biofilm growth normally takes place and may extend further along the water flow pathway.

Preferably, strips 256 have an oxygen permeability which is lower than that of oxygen-permeable membrane wall portion 254 by more than one order of magnitude. Strips 256 may be realized, for example by coating a corresponding strip of the water-impermeable, oxygen-permeable membrane wall portion 254 with an oxygen-impermeable material, such as a contact adhesive, ink, drying adhesive, hot adhesive. Strip 256 alternatively may be in the form of a strip of a generally low permeability polymer such as polyethylene or polypropylene, heat laminated onto oxygen-permeable membrane wall portion 254 or arranged on oxygen-permeable membrane wall portion 254 and held thereon by folding of the sleeve.

Strips 256 may be made of a pressure sensitive tape such as duct tape. It should be noted that strips 256 should be chosen to be adhesive or adherent to water-impermeable, oxygen-permeable membrane wall portion 254.

It is further noted that oxygen impermeable strips 256 may be applied on either or both of the water side and the air side of oxygen permeable wall portion 254. The choice of the side on which to apply the non-permeable material is generally made based on production process considerations.

Preferably an additional spacer 257 is folded outside of and together with pathway 230. Spacer 253 is typically a plastic netting or dimpled sheet, which maintains a spacing between adjacent inside walls of pathway 230, thus allowing water movement between adjacent wall surfaces of the membrane-enclosed water flow pathway 230. Similarly, spacer 257 is typically a plastic netting or dimpled sheet, which maintains a spacing between adjacent outside walls of pathway 230, thus allowing air movement between adjacent outside wall surfaces of the membrane-enclosed water flow pathway 230.

The nettings for either of spacers 253 and 257 are preferably bi-planar- or tri-planar. The dimpled sheets for either of spacers 253 and 257 can include one sided or double sided dimples. The thickness of spacers 253 and 257 can be between approximately 1-20 mm and most preferably is between 5-10 mm Spacers 253 and 257 are preferably formed of a water durable material having a compressive strength of above 2 ton/m², most preferably above 20 ton/m². Preferably the material is suitable for folding at a diameter of at least 2 inches. Preferred materials for the spacers include plastic materials such as polyethylene, polyethylene terephthalate (PET), polypropylene, polyamide and polyacetal. Spacers 253 and 257 may be identical, similar or dissimilar.

The water inlet and outlet flows in the embodiment of FIG. 7B are shown in FIG. 8B by arrows 258A and 258B. The air inlet and outlet flows in the embodiment of FIG. 7B are shown in FIG. 8B by arrows 259A and 259B respectively. It is appreciated that flow direction of any of the water and air could be in the opposite direction to what is shown by arrows 258A and 258B, and arrow 259A and 259B.

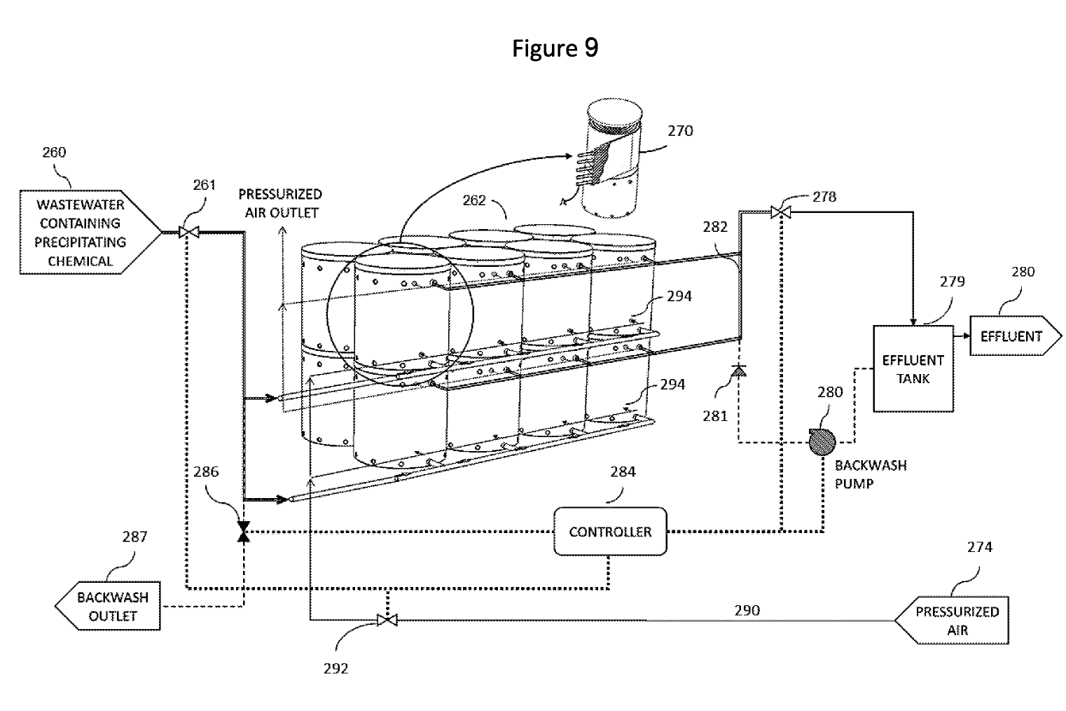

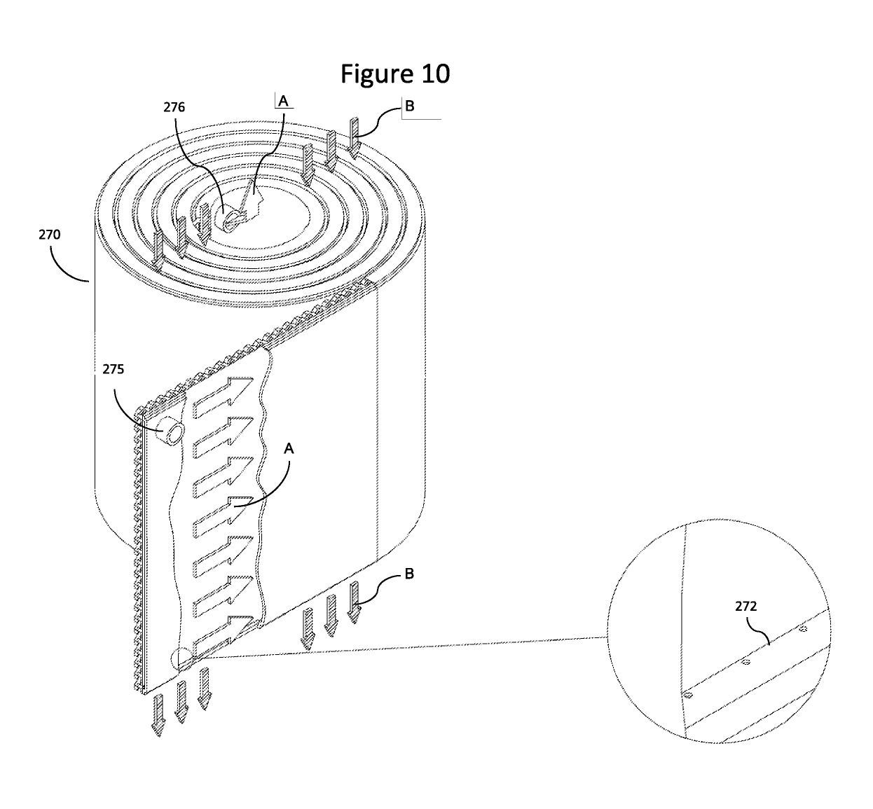

Reference is now made to FIG. 9, which is a simplified illustration of an alternative biofilm-based water treatment system constructed and operative in accordance with an embodiment of the present invention and to FIG. 10, which is a simplified pictorial illustration of water and air flows as well as structural details of the embodiment of FIG. 9.

The water treatment system of FIGS. 9 & 10 is operative to remove some dissolved pollutants from water by precipitation and also perform biological treatment of the water. The dissolved pollutants, which are at least partially precipitated out of the water, can include any one or more of phosphorous, sulfides and heavy metals.

The system of FIGS. 9 & 10 preferably receives water to be treated which is mixed together with a precipitating chemical at an inlet 260. The mixed water to be treated and the precipitating chemical are supplied to a biofilm-based water treatment subsystem 262, including a plurality of water flow pathways 270, constructed and operative generally in accordance with an embodiment of the present invention, such as that described hereinabove with reference to FIGS. 6A and 6B or such as that described in the prior art, for example in WO 2011073977, the description of which is hereby incorporated by reference.

Examples of some suitable precipitating chemicals, also known in the art as coagulants, are: ferric chloride, aluminum sulfate, sodium aluminate. Sodium sulfide is an example of a precipitating chemical useful for precipitation of heavy metals. Mixing of the precipitating chemical into the water may be performed in any suitable known manner.

It is seen that water to be treated, mixed with the precipitating chemical, passes through each water flow pathway 270 from an inlet 275 to a treated water outlet 276. Treated water outlets 276 of water flow pathways 270 are preferably coupled via piping 277 and a valve 278 to an effluent tank 279 having an effluent outlet 280.

Turning additionally to FIG. 10, it is seen that water flows through each water flow pathway 270 from inlet 275 to outlet 276 in a direction indicated by arrows A, while air passes between windings of the pathway in a direction indicated by arrows B.

Along at least part of the water flow pathway 270 there is disposed a perforated conduit 272. It is a function of perforated conduit 272 to diffuse air into the water flow pathway 270 either or both before and during periodic backflushing. The diffusing of pressurized air through holes of perforated conduit 272 into the water flow pathway 270, fluidizes the precipitated solids, thereby enabling them to be washed out during backflushing.

Back flushing is performed periodically in order to discharge solids that accumulate in and along the flow pathway with time, preferably by a controller 284, which initiates back flushing based on sensing pressure along the flow pathway 270 and/or according to preset time intervals. Controller 284 operates a backflush pump 285; a backflush outlet valve 286, coupled to a backflush outlet 287; a pressurized air valve 288, coupling a source of pressurized air 274 to perforated conduit 282 and valves 261 and 278.

Back flushing is performed periodically in order to discharge solids that accumulate in and along the flow pathway with time. The back flushing may be initiated by a controller 284 according to pressure measurement or constant time intervals or both. During back flushing, wastewater inlet valve 261 and treated water outlet valve 278 are closed, while drain valve 286 is opened, and back flushing pump 280 is operated. Preferably, pressurized air valve 292 is opened prior to back flushing and more preferably pressurized air valve 292 remains open to provide mixing and fluidization of the solids in the water during at least part of the back flushing. Back flushing is terminated according to any of a preset time or a measured quantity of water drained or draining water turbidity. Upon termination of the back flushing, back flushing pump 280 is stopped, drain valve 286 is closed, pressurized air valve 292 is closed and treated water outlet valve 278 together with wastewater inlet valve 261 are opened. Back flushing is terminated by controller 284 at a preset time after initiation or based on sensed quantities of backflushed material reaching backflush outlet 292 or the sensed turbidity of the backflushed liquid. Back flushing outlet from drain is preferably directed to subsequent processing such as thickening, dewatering and discharge.

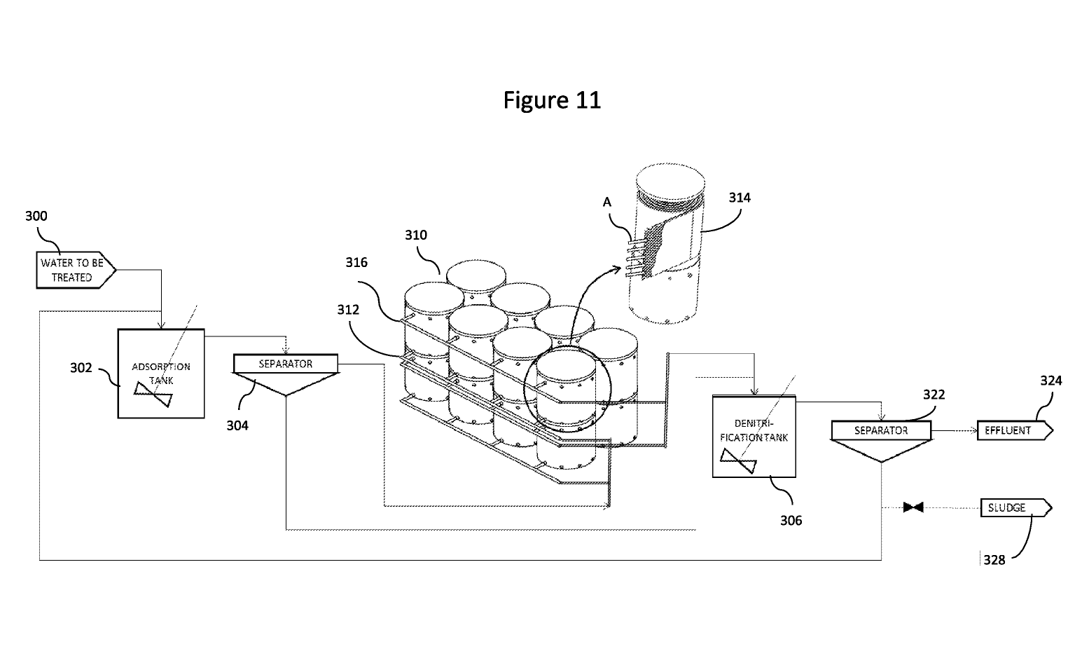

Reference is now made to FIG. 11, which is a simplified illustration of a further alternative biofilm-based clogging resistant water treatment system constructed and operative in accordance with an embodiment of the present invention.

The water treatment system of FIG. 11 preferably receives water to be treated containing both dissolved organic material and ammonium compounds at an inlet 300. The water to be treated is mixed with an activated sludge in a mixing and adsorption tank 302. Water containing dissolved ammonium compounds, is then transferred to a sludge-liquid separator 304, which separates sludge containing adsorbed and mostly non-oxidized organic material, which is supplied to a denitrification tank 306, from water containing dissolved ammonium compounds, which is supplied to a biofilm-based water treatment subsystem 310, constructed and operative generally in accordance with an embodiment of the present invention, such as that described hereinabove with reference to FIGS. 6A and 6B or such as that described in the prior art, for example in WO 2011073977, the description of which is hereby incorporated by reference.

It is appreciated that the water containing dissolved ammonium compounds received at biofilm-based water treatment subsystem 310 is supplied through an inlet manifold 312 to a plurality of membrane enclosed water flow pathways 314 and flows therethrough as indicated by arrows A to a nitrified water outlet manifold 316, thereby reducing the quantity of ammonium compounds in the water and thereby nitrifying the water.

In the biofilm-based water treatment subsystem 310, a biofilm that consumes the ammonium compounds is built up on the interior walls of membrane enclosed water flow pathways 314 and thus oxidizes the ammonium compound contained in the water flowing therethrough to nitrates. The organic material load in the water that reaches the biofilm-based water treatment subsystem 310 is relatively low due to earlier adsorption thereof by contact with the activated sludge. As a result, the biofilm buildup on the interior walls of enclosed water flow pathways 314 is relatively thin and water flow pathways 314 does not get clogged.

Water from nitrified water outlet 316 is preferably supplied to a denitrification tank 306 together with sludge from separator 304. In denitrification tank 306, the nitrified water is mixed with the activated sludge containing adsorbed non-oxidized organic material. As a result the activated sludge oxidizes the organic material using nitrates to complete both processes of denitrification and organic materials oxidation.

Optionally, if oxidation of organic material is limited by nitrate concentration, an additional aeration may be provided. In some embodiments intermittently by diffusers placed in the denitrification tank. In other embodiments continuously by an additional aeration tank downstream the denitrification tank and upstream the sludge—liquid separator.

Denitrified water from denitrification tank 306 is preferably supplied to a sludge-liquid separator 322. Treated water from the separator 322 is preferably employed as an effluent through effluent outlet 324. Most of the sludge from separator 322, which sludge consumed most of the organic material, is returned to mixing and adsorption tank 302 while a small fraction of the sludge is removed from the system via a sludge outlet 328. The fraction of sludge removed from the bottom of separator 322 is adjusted to maintain a desired constant concentration of sludge in tanks 302 and 306.

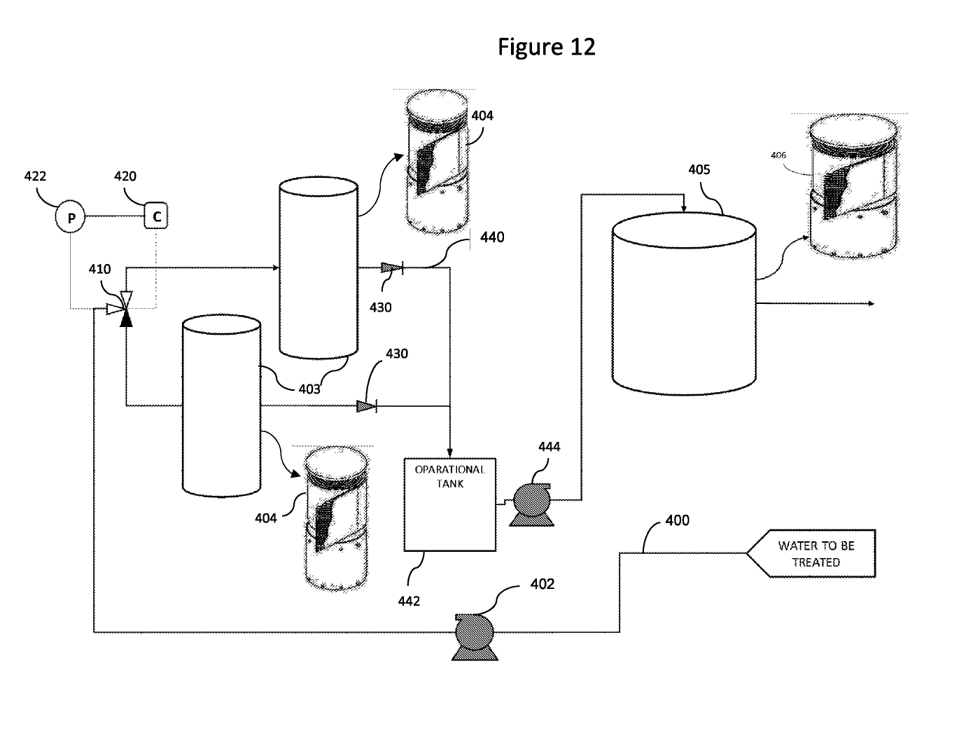

Reference is now made to FIG. 12, which is a simplified illustration of yet another alternative clogging resistant biofilm-based water treatment system constructed and operative in accordance with an embodiment of the present invention.

The alternative clogging resistant biofilm-based water treatment system of FIG. 12 preferably includes an inlet 400, which may be associated with a pump 402, which supplies water to be treated to an upstream subsystem 403 that includes two or more biofilm-based water treatment units 404, only some of which are operative at any given time, and thereafter to a downstream subsystem 405 including at least one biofilm-based water treatment unit 406. Each of the biofilm-based water treatment units 404 and 406 preferably includes an oxygen-permeable membrane-enclosed, water impermeable water flow pathway, which provides biofilm-based water treatment. Preferably the oxygen-permeable membrane-enclosed, water impermeable water flow pathway is coiled. More preferably the oxygen-permeable membrane-enclosed, water impermeable water flow pathway is designed in accordance with the embodiment shown in FIGS. 6A and 6B or in accordance with embodiments described in the prior art, such as WO 2011073977, the description of which is hereby incorporated by reference.

Downstream subsystem 405 does not generally become clogged by growth of a thick biofilm along at least part of the flow pathway of the units 406 therein. Clogging is prevented by the reduction of most of the load of organic material contained in the water by operating units 404 in upstream subsystem 403, which as a result become clogged by growth of a biofilm therein.

Upon clogging of one or more operating units 404 of upstream subsystem 403, typically after 2-4 months, the flow of water to be treated is redirected to non-operating units 404 of upstream subsystem 403 preferably automatically by a valve assembly 410. During the time period that clogged units 404 of upstream subsystem 403 are non-operative, they become unclogged due to endogenous decay.

The time required for this decay can be optionally shortened by various means, including, for example: addition of chemicals such as a hypochlorite solution, caustic soda solution or specific enzymes. Water may be circulated through the non-operative units 404 in order to provide mixing and turbulence. As a further option, air may be periodically sparged into the units 404 in order to provide shearing and turbulence and thus shorten the decay time.

Valve assembly 410 is preferably controlled by a controller 420, which either operates on a fixed time schedule or on the basis of sensed clogging based on inputs from one or more pressure sensors 422, to redirect a flow of water to be treated from one or more current operating units 404 to one or more currently non-operating units 404.

Each of the units 404 of biofilm-based water treatment upstream subsystem 403 preferably includes a pathway whose length is 20-40% of the combined length of the entire water treatment flow path, including that incorporated in one of upstream units 404 and in downstream subsystem units 406. Most preferably, the length of the flow path in each of the upstream units 404 is 10-30 meters, and the length of the flow path of the downstream unit 406 is 40-70 meters.

Treated, partially purified water output from the upstream operating biofilm-based water treatment units 404 of upstream subsystem 403 is supplied to downstream biofilm-based water treatment subsystem 405, preferably via one or more non-return valves 430, to complete the water treatment process.

In a preferred embodiment, the partially treated water 440 from upstream subsystem 403 is supplied to operational tank 442, from which it is pumped by pump 444 to downstream subsystem 405 for further treatment thereof.

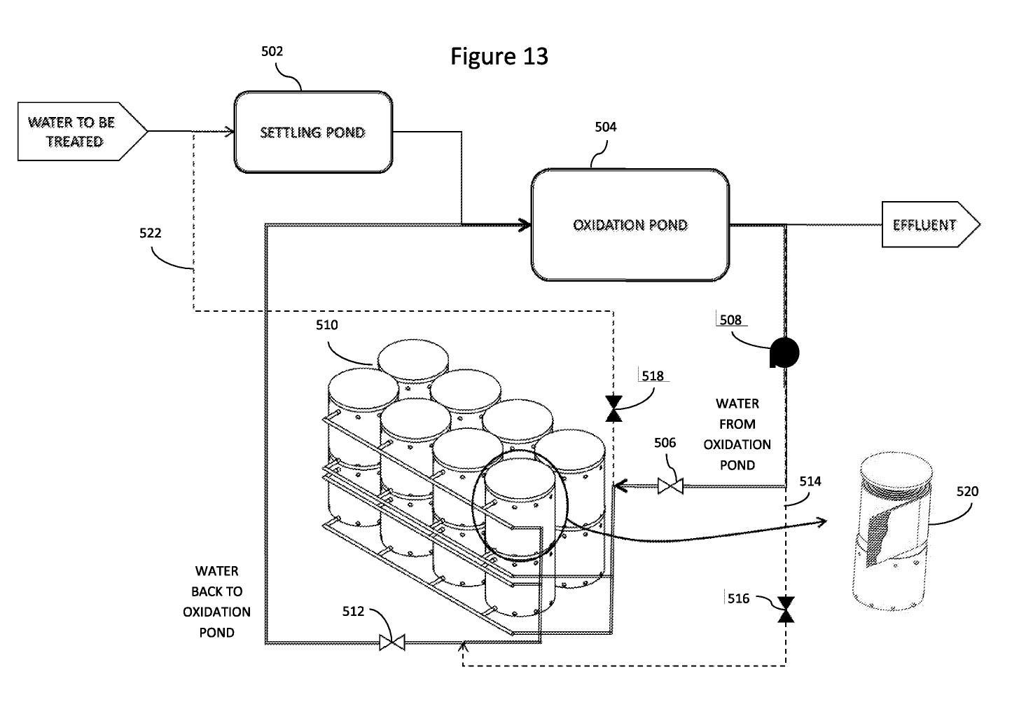

Reference is now made to FIG. 13, which is a simplified illustration of yet another alternative clogging-resistant biofilm-based water treatment system which incorporates a settling pond and an oxidation pond in accordance with an embodiment of the present invention.

In one embodiment, as seen in FIG. 13, water to be treated is supplied to one or more conventional settling ponds 502. If multiple settling ponds are provided, they may operate in parallel or sequentially. In one or more settling ponds 502, most of the inorganic material and suspended solids sink to the bottom. Water containing ammonium compounds and dissolved organic material is supplied from the one or more settling ponds 502 to one or more conventional oxidation ponds 504, at which a process of at least partial removal of organic material takes place. The effluent from the one or more oxidation ponds 504 is circulated via a pump 508 through a membrane-supported biofilm-based water treatment subsystem 510 in order to remove nitrogen from the effluent.

In a different embodiment, no settling pond is provided or alternatively a different conventional pretreatment is utilized upstream the oxidation pond.

Subsystem 510 is preferably constructed and operative as described hereinabove with reference to FIGS. 6A and 6B or alternatively may be constructed and operative in accordance with the teaching of the prior art, for example WO 2011073977. The operation of subsystem 510 mostly produces nitrification of the effluent by oxidizing ammonium compounds to nitrates. It is noted that additional processes might occur to some extent in subsystem 510, such as oxidation of organic material and denitrification of the produced nitrate with the dissolved organic material present in the water.

Following such nitrification, nitrified water from membrane-supported biofilm-based water treatment subsystem 510 is circulated back to one or more oxidation pond 504 or to another upstream or downstream oxidation pond (not shown) for denitrification thereof.

A first advantage of the above-described process is higher effluent quality than obtained in the conventional process, resulting from the increased aeration by the biofilm-based water treatment subsystem 510. A further advantage of the process is the use of the nitrates that are dissolved in the water, which nitrates are circulated to the oxidation pond 504, as an oxidant, thereby enhancing the oxidation process in the one or more oxidation ponds 504.

It is noted that clogging of the subsystem 510 by biofilm buildup does not generally occur, due to the relatively low load of organic material in the effluent of the oxidation pond 504, which is supplied to system 510, as a result of the partial removal of organic material that takes place in the one or more oxidation ponds 504.

Subsystem 510 may optionally be backflushed with effluent from oxidation pond 504 or from a point downstream thereof. Backflushing of subsystem 510 is normally required in order to dispose of suspended solids that settle along the flow pathway or excess solids that slough off of the biofilm therein. Backflushing is generally performed by reversal of the flow direction through the flow pathways of units 520 of subsystem 510. During normal operation valves 506 and 512 are open whereas valves 516 and 518 are closed. During backflushing of at least part of units 520 of subsystem 510, valves 506 and 512 are closed whereas valves 516 and 518 are open. The switching between the normally open valves 506 and 512 and normally closed valves 516 and 518 is preferably controlled by a controller (not shown) according to any of inlet pressure or preset time intervals. Backflushing water outlet 522 is preferably discharged to settling pond 502, or to a different point upstream the oxidation pond 504.

It will be appreciated by persons skilled in the art that the present invention is not limited by what has been particularly shown and described hereinabove. Rather the scope of the present invention includes combinations and subcombinations of features described above as well as modifications and improvements thereof that are not in the prior art.

1.-75. (canceled)

76. A clogging resistant biofilm-based water treatment system, comprising: a membrane-enclosed water flow pathway including at least one water-impermeable, oxygen-permeable membrane wall portion extending along said pathway and at least another wall portion extending along at least part of said pathway wherein said at least another wall portion comprises at least one water-impermeable, oxygen-impermeable wall portion extending along at least part of said pathway, wherein biofilm growth and consequent clogging generally takes place along said water-impermeable, oxygen-permeable membrane wall portion and clogging does not take place along said water-impermeable, oxygen-impermeable wall portion.

77. The clogging resistant biofilm-based water treatment system according to claim 76 and wherein said at least one water-impermeable, oxygen-impermeable wall portion extends continuously along at least part of said pathway.

78. The clogging resistant biofilm-based water treatment system according to claim 76 and wherein said at least one water-impermeable, oxygen-impermeable wall portion comprises plural water-impermeable, oxygen-impermeable wall portions.

79. The clogging resistant biofilm-based water treatment system according to claim 78 and wherein said plurality of water-impermeable, oxygen-impermeable wall portions and said plurality of water-impermeable, oxygen-permeable wall portions extends continuously along at least part of said pathway.

80. The clogging resistant biofilm-based water treatment method comprising:
causing water to be treated to flow along a water treatment system according to claim 76 wherein biofilm growth and consequent clogging generally takes place along said water-impermeable, oxygen-permeable membrane wall portion and clogging does not take place along said water-impermeable, oxygen-impermeable wall portion.

81. The clogging resistant biofilm-based water treatment method according to claim 80 and wherein the causing water to be treated to flow includes causing water containing organic material and ammonium compounds to flow along said pathway.

82. The clogging resistant biofilm-based water treatment method comprising:
causing water to be treated to flow along a water treatment system according to claim 78, wherein biofilm growth and consequent clogging which prevents water flow but not oxygen permeation generally takes place along said water-impermeable, oxygen-permeable membrane wall portion and clogging which prevents water flow does not take place along said water-impermeable, oxygen-impermeable wall portions, such that water to be treated can flow along generally the entire length of said pathway notwithstanding biofilm clogging of said plurality of water-impermeable, oxygen-permeable membrane wall portions into engagement with said biofilm on said water-impermeable, oxygen-permeable wall portions and oxygen diffuses into said biofilm.

83. A clogging resistant biofilm-based water treatment method, comprising:
causing water to be treated, containing both dissolved organic material and ammonium compounds, to be mixed with sludge, producing a first mixture containing suspended biomass and resulting in adsorption by said sludge of at least most of said dissolved organic material;
following said adsorption, separating said sludge having adsorbed thereon said dissolved organic material, from liquid, which contains said ammonium compounds;
causing said liquid to be treated to flow along an oxygen-permeable membrane-enclosed, water impermeable water flow pathway, thereby biologically nitrifying said ammonium compounds in said liquid;
following said nitrifying, mixing said liquid containing nitrified ammonium compounds with said sludge having adsorbed thereon said dissolved organic material to create a second mixture, thereby producing denitrification of said nitrified ammonium compounds and oxidation of said organic material which had been adsorbed onto said sludge; and
following said denitrification, separating said sludge from water, wherein said water has substantially decreased amounts of dissolved organic material and ammonium compounds as compared with said water to be treated.

84. The clogging resistant biofilm-based water treatment method of claim 83 wherein said oxidation of said organic material which had been adsorbed onto said sludge is performed in part by aeration.

85. The clogging resistant biofilm-based water treatment method of claim 84 wherein said aeration is performed downstream of said denitrification and upstream of said separating said sludge from water.

86. The clogging resistant biofilm-based water treatment method according to claim 83 and also comprising utilizing said sludge separated from said water following said denitrification to be mixed with said water to be treated, which contains both dissolved organic material and ammonium compounds.

87. The clogging resistant biofilm-based water treatment method according to claim 85 and wherein said flow path is spirally wound and said at least one generally vertical airflow passageway has a generally spiral cross section.

88. The water treatment method according claim 80 and also comprising:
discharging treated water directly from said membrane-enclosed water flow pathway without filtering.

89. A water treatment system, comprising:
at least one oxidation pond receiving water from said at least one setting pond; and
a membrane-enclosed water flow pathway including at least one water-impermeable, oxygen-permeable membrane wall portion extending along said pathway, receiving water from said at least one oxidation pond and discharging water back to any of said at least one oxidation pond and upstream of said at least one oxidation pond, wherein clogging normally does not take place along said membrane-enclosed water flow pathway.

90. The water treatment system according to claim 89 and further comprising any of at least one settling pond and at least one anaerobic pond upstream of said at least one oxidation pond.

91. The water treatment system according to claim 76 and also comprising:
at least one settling pond receiving water to be treated; and
at least one oxidation pond receiving water from said at least one settling pond,
said membrane-enclosed water flow pathway receiving water from said at least one oxidation pond and discharging water back to at least one of said at least one settling pond and said at least one oxidation pond.
